(19) United States
(12) Patent Application Publication
(10) Pub. No.: US 2025/0053805 A1
(43) Pub. Date: Feb. 13, 2025

(54) MULTIWAVELET-BASED OPERATOR LEARNING FOR DIFFERENTIAL EQUATIONS

(71) Applicant: University of Southern California, Los Angeles, CA (US)

(72) Inventors: Paul Bogdan, Los Angeles, CA (US); Gaurav Gupta, Los Angeles, CA (US); Xiong Ye Xiao, Los Angeles, CA (US)

(21) Appl. No.: 18/710,880

(22) PCT Filed: Sep. 16, 2022
(86) PCT No.: PCT/US2022/043885

§ 371 Date: May 16, 2024

Related U.S. Application Data
(60) Provisional application No. 63/280,857, filed on Nov. 18, 2021.

(51) Int. Cl. G06N 3/08; G06N 3/044; G06N 3/045; G06N 3/0464

(52) U.S. Cl. CPC G06N 3/08; G06N 3/044; G06N 3/045; G06N 3/0464

(57) ABSTRACT

The solution of a partial differential equation can be obtained by computing the inverse operator map between the input and the solution space. Described herein is a multiwavelet-based neural operator learning scheme that compresses the associated operator's kernel using fine-grained wavelets. The system embeds the inverse multiwavelet filters to learn the projection of the kernel onto fixed multiwavelet polynomial bases. The projected kernel is trained at multiple scales derived from using repeated computation of multiwavelet transform. This allows learning the complex dependencies at various scales and results in a resolution-independent scheme. These techniques exploit the fundamental properties of the operator's kernel, which enables numerically efficient representation. These techniques show significantly higher accuracy in a large range of datasets. By learning the mappings between function spaces, these techniques can be used to find the solution of a high-resolution input after learning from lower-resolution data.

### CROSS-REFERENCE TO RELATED PATENT APPLICATIONS

This application claims the benefit of priority under 35 U.S.C. § 119 to U.S. Provisional Patent Application Ser. No. 63/280,857, entitled “MULTIWAVELET-BASED OPERATOR LEARNING FOR DIFFERENTIAL EQUATIONS,” filed Nov. 18, 2021, the contents of such application being hereby incorporated by reference in its entirety and for all purposes as if completely and fully set forth herein.

### STATEMENT REGARDING FEDERALLY SPONSORED RESEARCH OR DEVELOPMENT

This invention was made with government support under grant nos. 66001-17-1-4044 awarded by the Defense Advanced Research Projects Agency (DARPA), Career CPS/CNS-1453860 awarded by the National Science Foundation (NSF), CCF-1837131 awarded by the NSF, MCB-1936775 awarded by the NSF, CNS1932620 awarded by the NSF, and W911NF-17-1-0076 awarded by the Army Research Office (ARO). The government has certain rights in the invention.

### BACKGROUND

The present techniques relate generally to the field of multiwavelet-based operators for differential equations.

### SUMMARY

Many natural and human-built systems (e.g., aerospace, complex fluids, neuro-glia information processing) exhibit complex dynamics characterized by partial differential equations (PDEs). For example, the design of wings and airplanes that are robust to turbulence can utilize learning of complex PDEs. Along the same lines, complex fluids (gels, emulsions) are multiphasic materials characterized by a macroscopic behavior modeled by non-linear PDEs. Understanding their variations in viscosity as a function of the shear rate is useful for many engineering projects. Moreover, modelling the dynamics of continuous and discrete cyber and physical processes in complex cyber-physical systems can be achieved through PDEs.

Learning PDEs (e.g., mappings between infinite-dimensional spaces of functions), from trajectories of variables, generally utilize machine learning techniques, such as deep neural networks (NNs). Towards this end, a stream of work aims at parameterizing the solution map as deep NNs. One issue, however, is that the NNs are tied to a resolution during training, and therefore, may not generalize well to other resolutions, thus, requiring retraining (and possible modifications of the model) for every set of discretizations. In parallel, another stream of work focuses on constructing the PDE solution function as a NN architecture. This approach, however, is designed to work with one instance of a PDE and, therefore, upon changing the coefficients associated with the PDE, the model has to be re-trained. Additionally, the approach is not a complete data-dependent one, and hence, cannot be made oblivious to the knowledge of the underlying PDE structure. Finally, the closest stream of work to the problem we investigate is represented by the “Neural Operators”. Being a complete data-driven approach, the neural operators method aims at learning the operator map without having knowledge of the underlying PDEs. The neural operators have also demonstrated the capability of discretization-independence. Obtaining the data for learning the operator map could be prohibitively expensive or time consuming (e.g., aircraft performance to different initial conditions). To be able to better solve the problem of learning the PDE operators from scarce and noisy data, we would ideally explore fundamental properties of the operators that have implication in data-efficient representation.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. As used in the specification and in the claims, the singular form of ‘a’, ‘an’, and ‘the’ include plural referents unless the context clearly dictates otherwise.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings are not intended to be drawn to scale. Like reference numbers and designations in the various drawings indicate like elements. For purposes of clarity, not every component may be labeled in every drawing. In the drawings:

FIG. 1 illustrates an implementation of a multiwavelet representation of the Kernel. (i) Given kernel K(x, y) of an integral operator T, (ii) the bases with different measures (μ₀, μ₁) at two different scales (coarse=0, fine=1) projects the kernel into 3 components Aᵢ, BᵢCᵢ. (iii) The decomposition yields a sparse structure, and the entries with absolute magnitude values exceeding 1e⁻⁸ are shown in black. Given projections at any scale, the finer/coarser scale projections can be obtained by reconstruction/decomposition using a fixed multiwavelet filters Hⁱ and Gⁱ, i=0,1.

FIG. 2 illustrates an implementation of a MWT model architecture. (Left) Decomposition cell using 4 neural networks (NNs) A, B and C, and T (for the coarsest scale L) performs multiwavelet decomposition from scale n+1 to n. (Right) Reconstruction module using pre-defined filters H⁽ⁱ⁾, G⁽ⁱ⁾ performs inverse multiwavelet transform from scale n−1 to n.

FIG. 3 illustrates plots of the output of an implementation of the KdV equation. (Left) An input u₀(x) with λ=0.02. (Right) The predicted output of the MWT Leg model learning the high fluctuations.

FIG. 4 illustrates a plot of an implementation of the comparison of MWT by varying the degree of fluctuations λ in the input with resolution s=1024. For each convolution, we fix the number of Fourier bases as kₘ. For FNO, the width is 64.

FIG. 5 illustrates a plot of an implementation of the relative L2 error vs epochs for MWT Leg with different number of OP basis k=1, . . . ,6.

FIG. 6 illustrates a plot of an implementation of Burgers' Equation validation at various input resolution s. Our methods: MWT Leg, Chb.

FIG. 7 illustrates plots of an implementation of wavelet dilation and translation. The dilation and translation of the mother wavelet function from left to right. The scale=0 represents the mother wavelet function with its measure μ₀. The higher scales (1,2) are obtained by scale/shift with a factor of 2. (i) Mother wavelet using shifted Legendre polynomial P₃(2x−1) with the uniform measure μ₀, while (ii) uses shifted Chebyshev polynomial T₃(2x−1) with the non-uniform measure μ0.

FIG. 8 illustrates plots of an implementation of prediction at higher resolution: The proposed model (MWT) learns the function mapping using the data with a coarse resolution, and can predict the output at a higher resolution. (i) The resolution-extension experiment pipeline. (ii) An example of down-sampling of the associated functions used in the training. (iii) We show two test samples with example-1 marked as blue while example-2 is marked as red. Left: input functions (u₀) of the examples. Right: corresponding outputs u(x, 1) at s=8192 from MWT Leg (trained on s=256) of the 2 examples, and their higher-resolution (s=8192) ground truth (dotted line).

FIG. 9 illustrates a plot of an implementation of Relative L2 error vs epochs for MWT Leg with different number of OP basis k.

FIG. 10 illustrates plots of two examples of an implementation of a 4th order Euler-Bernoulli equation. Left: Two input functions (u₀) in different colors. Right: corresponding outputs (u(x, 1)) in the same color.

FIG. 11 illustrates Sample input/output for an implementation of the PDE as described herein. Left: Two input functions (u₀) examples in Red and Blue. Right: corresponding outputs (u(x, 1)) in the same color.

FIG. 12 illustrates an implementation of an example operator mapping that may useful in understanding one or more of the techniques described herein, in accordance with one or more implementations.

FIG. 13 illustrates an example mathematical representation of an implementation of an example neural operator, in accordance with one or more implementations.

FIG. 14 illustrates a comparison between an implementation of a Pseudo-differential operator and a Calderón-Zygmund operator, in accordance with one or more implementations.

FIG. 15 illustrates an example illustration of an implementation of a multiwavelet transform, in accordance with one or more implementations.

FIG. 16 illustrates example illustrations of an implementation of multiwavelet transforms with various parameters, in accordance with one or more implementations.

FIG. 17 illustrates properties leading to compression for an implementation of multiwavelet transforms, in accordance with one or more implementations.

FIG. 18 illustrates an implementation of vanishing moments that lead to compression in the multiwavelet domain, in accordance with one or more implementations.

FIG. 19 illustrates example plots of an implementation of multiwavelets compressing a kernel, in accordance with one or more implementations.

FIG. 20 illustrates an implementation of example multiwavelet filters, in accordance with one or more implementations.

FIG. 21 illustrates an implementation of the decoupling of scale interactions for multi-scale learning, in accordance with one or more implementations.

FIG. 22 illustrates an example dataflow diagram of an implementation of a multiwavelet neural operator, in accordance with one or more implementations.

FIG. 23 illustrates example results of an example model of an implementation of a two-dimensional Darcy flow, in accordance with one or more implementations.

FIG. 24 illustrates example results of an implementation of modeling the Navier-Stokes equations with low turbulence using the techniques described herein, in accordance with one or more implementations.

FIG. 25 illustrates example results of an implementation of modeling the Navier-Stokes equations with high turbulence using the techniques described herein, in accordance with one or more implementations.

FIG. 26 illustrates an example computing system that may be used to perform the techniques described herein.

FIG. 27 illustrates an example flowchart of a method used to perform the techniques described herein.

FIGS. 28A and 28B illustrate block diagrams depicting implementations of computing devices useful in connection with the methods and systems described herein.

FIG. 29 illustrates an example recurrent neural architecture, in accordance with one or more implementations.

### DETAILED DESCRIPTION

We present here some technical preliminaries that are used in the present disclosure. The literature for some of the topics is vast, and we list only the properties that are useful specifically for the techniques described herein.

Our intuition is to transform the problem of learning a PDE to a domain where a compact representation of the operator exists. With a mild assumption regarding the smoothness of the operator's kernel, except finitely many singularities, the multiwavelets, with their vanishing moments property, sparsify the kernel in their projection with respect to (w.r.t.) a measure. Therefore, learning an operator kernel in the multiwavelet domain is feasible and data efficient. The wavelets have a rich history in signal processing, and are popular in audio, image compression. For multiwavelets, the orthogonal polynomial (OP) w.r.t. a measure emerges as a natural basis for the multiwavelet subspace, and an appropriate scale/shift provides a sequence of subspaces which captures the locality at various resolutions. We generalize and exploit the multiwavelets concept to work with arbitrary measures which opens-up new possibilities to design a series of models for the operator learning from complex data streams.

We incorporate the multiwavelet filters derived using a variety of the OP basis into our operator learning model, and show that the proposed architecture outperforms the existing neural operators. Our main contributions are as follows: (i) Based on some fundamental properties of the integral operator's kernel, we develop a multiwavelet-based model which learns the operator map efficiently. (ii) For the 1-D dataset of non-linear Korteweg-de Vries and Burgers equations, we observe an order of magnitude improvement in the relative L2 error (as described herein). (iii) We demonstrate that the proposed model is in validation with the theoretical properties of the pseudo-differential operator (as described herein). (iv) We show how the proposed multiwavelet-based model is robust towards the fluctuation strength of the input signal (as described herein). (v) Next, we demonstrate the applicability on higher dimensions of 2-D Darcy flow equation (as described herein), and finally show that the proposed approach can learn at lower resolutions and generalize to higher resolutions.

We start by defining the problem of operator learning as described herein. We define the multiwavelet transform for the proposed operator learning problem and derive the transformation operations across different scales. Then the proposed operator learning model is outlined. Finally, we list some of the useful properties of the operators which leads to an efficient implementation of multiwavelet-based models.

Given two functions a (x) and u(x) with x∈D, the operator is a map T such that Ta=u. Formally, let A and [symbol] be two Sobolev spaces H [symbol] ^{s,p} (s>0, p≥1), then the operator T is such that T: A→ [symbol] . The Sobolev spaces are useful in the analysis of partial differential equations (PDEs), and we restrict our attention to s>0 and p=2. Note that, for s=0, the [symbol] ^{0,p} coincides with L^{p}, and, ƒ∈ [symbol] ^{0,p} does not necessarily have derivatives in L^{p}. We choose p=2 in order to be able to define projections with respect to (w.r.t.) measures μ in a Hilbert space structure.

We take the operator T as an integral operator with the kernel K:D×D→L² such that

$$Ta ( x ) = {\int }_{D} K ( x , y ) a ( y ) dy \qquad ( 1 )$$

For the case of inhomogeneous linear PDEs, [symbol] =ƒ, with ƒ being the forcing function, [symbol] is the differential operator, and the associated kernel is commonly termed as Green function. In our case, we do not put the restriction of linearity on the operator. From eq. (1), it is apparent that learning the complete kernel K (.,.) would solve the operator map problem, but it is not necessarily a numerically feasible solution. Indeed, a better approach would be to exploit possible useful properties (as described herein) such that a compact representation of the kernel can be made. For an efficient representation of the operator kernel, we can determine an appropriate subspace (or sequence of subspaces), and projection tools to map to such spaces.

Norm with respect to measures: Projecting a given function onto a fixed basis may utilize a measure dependent distance. For two functions ƒ and g, we take the inner product w.r.t measure μ as [symbol] ƒ, g [symbol] u=∫ƒ(x)g(x)dμ(x), and the associated norm as ∥ƒ∥u= [symbol] ƒ, ƒ [symbol] _{μ}^{1/2}. We now discuss the next ingredient, which refers to the subspaces that can be used to project the kernel.

### Multiwavelet Transform

In this section, we briefly overview the concept of multiwavelets and extend it to work with non-uniform measures at each scale. The multiwavelet transform synergizes the advantages of orthogonal polynomials (OPs) as well as the wavelets concepts, both of which have a rich history in the signal processing. The properties of wavelet bases like (i) vanishing moments, and (ii) orthogonality can effectively be used to create a system of coordinates in which a wide class of operators (as described herein) have nice representation. Multiwavelets go few steps further, and provide a fine-grained representation using OPs, but also act as basis on a finite interval. For the rest of this section, we restrict our attention to the interval [0, 1]; however, the transformation to any finite interval [a, b] could be straightforwardly obtained by an appropriate shift and scale.

Multi Resolution Analysis: We begin by defining the space of piecewise polynomial functions, for k∈ [symbol] and [symbol] ∈ [symbol] ⁺∪{0} as, Vₙ^{k}=∪ₗ₌₀²^{^{n−1}} {ƒ|deg(ƒ)<k for x∈(2⁻ⁿl, 2⁻ⁿ(l+1))∧0, elsewhere}. Clearly, dim(Vₙ^{k})=2ⁿk, and for subsequent n, each subspace is contained in another as shown by the following relation:

$${V}_{0}^{k} ⊂ {V}_{1}^{k} … ⊂ {V}_{n - 1}^{k} ⊂ {V}_{n}^{k} ⊂ … \qquad ( 2 )$$

Similarly, we define the sequence of measures μ₀μ₁, . . . such that ƒ∈Vₙ^{k} is measurable w.r.t. μₙ and the norm of ƒ is taken as ∥ƒ∥= [symbol] ƒ, ƒ [symbol] _{μ}_{ₙ}^{1/2}. Next, since Vₙ₋₁^{k}⊂Vₙ^{k}, we define the multiwavelet subspace as Wₙ^{k} for n∈ [symbol] ⁺∪{0}, such that

$${V}_{n + 1}^{k} = {V}_{n}^{k} ⊕ {W}_{n}^{k} , {V}_{n}^{k} ⊥ {W}_{n}^{k} \qquad ( 3 )$$

For a given OP basis for V₀^{k} as ∅₀, ∅₁, . . . , ∅ₖ₋₁ w.r.t. measure μ₀, a basis of the subsequent spaces Vₙ^{k}, n>1 can be obtained by shift and scale (hence the name, multi-scale) operations of the original basis as follows:

$$\begin{matrix}{∅}_{jl}^{n} ( x ) = {2}^{n / 2} {∅}_{j} ( {2}^{n} x - 1 ) , & j = 0 , 1 , … , k - 1 ,\end{matrix} \qquad ( 4 )$$

$$l = 0 , 1 , … , {2}^{n} - 1 , w . r . t . {μ}_{n} ,$$

where, un is obtained as the collections of shift and scale of μ₀, accordingly.

Multiwavelets: For the multiwavelet subspace W₀^{k}, the orthonormal basis (of piecewise polynomials) are taken as ψ₀, ψ₁, . . . , ψₖ₋₁ such that [symbol] ψᵢ, ψⱼ [symbol] μ₀ for i≠j and 1, otherwise. From eq. (3), Vₙ^{k}⊥Wₙ^{k}, and since Vₙ^{k} spans the polynomials of degree at most k, therefore, we conclude that

$$\begin{matrix}{\int }_{0}^{1} {x}^{i} {ψ}_{j} ( x ) d {μ}_{0} ( x ) = 0 & ∀ 0 \leq j , i < k . ( vanishing moments )\end{matrix} \qquad ( 5 )$$

Similarly to eq. (4), a basis for multiwavelet subspace Wₙ^{k} are obtained by shift and scale of ψᵢ as

$${ψ}_{jl}^{n} ( x ) = {2}^{\frac{n}{2}} {ψ}_{j} ( {2}^{n} x - l )$$

and ψⱼₗⁿ are orthonormal w.r.t. measure μₙ, e.g. [symbol] ψⱼₗⁿ, ψ_{j′l′} [symbol] _{μ}_{ₙ}=1 if j=j′, l=l′ and 0 otherwise. Therefore, for a given OP basis for V₀^{k} (for example, Legendre, Chebyshev polynomials), we can compute ψᵢ, and a complete basis set at all the scales can be obtained using scale/shift of ∅ᵢ, ψᵢ.

Note: Since V₁^{k}=V₀^{k}⊕W₀^{k} from eq. (3), therefore, for a given basis ∅ᵢ of V₀^{k} w.r.t. measure μ₀ and ∅ⱼₗⁿ as a basis for V₁^{k} w.r.t. μ₁, a set of basis ψᵢ can be obtained by applying Gram-Schmidt Orthogonalization using appropriate measures. We refer the reader to supplementary materials for the detailed procedure.

Note: Since V₀^{k} and W₀^{k} lives in V₁^{k}, therefore, ∅ᵢ, ψᵢ can be written as a linear combination of the basis of V₁^{k}. We term these linear coefficients as multiwavelet decomposition filters (H⁽⁰⁾, H⁽¹⁾, G⁽⁰⁾, G⁽¹⁾), since they are transforming a fine n=1 to coarse scale n=0. A uniform measure (μ₀) version is discussed in, and we extend it to any arbitrary measure by including the correction terms Σ⁽⁰⁾ and Σ⁽¹⁾. We refer to supplementary materials for the complete details. The capability of using the non-uniform measures enables us to apply the same approach to any OP basis with finite domain, for example, Chebyshev, Gegenbauer, etc.

For a given ƒ(x), the multiscale, multiwavelet coefficients at the scale n are defined as sₗⁿ=[ [symbol] ƒ, ∅ᵢₗⁿ [symbol] _{μ}_{ₙ}]ᵢ₌₀^{k-1}, dₗⁿ=[ [symbol] ƒ, ψᵢₗⁿ [symbol] _{μ}_{ₙ}]ᵢ₌₀^{k-1}, respectively, w.r.t. measure μₙ with sₗⁿ, dₗⁿ∈ [symbol] ^{k×2}^{ⁿ}. The decomposition/reconstruction across scales is written as

$${s}_{l}^{n} = {H}^{( 0 )} {s}_{2 l}^{n + 1} + {H}^{( 1 )} {s}_{2 l + 1}^{n + 1} , \qquad ( 6 )$$

$${d}_{l}^{n} = {G}^{( 0 )} {s}_{2 l}^{n + 1} + {H}^{( 1 )} {s}_{2 l + 1}^{n + 1} . \qquad ( 7 )$$

$${s}_{2 l}^{n + 1} = {\sum }^{( 0 )} ( {H}^{( 0 ) T} {s}_{l}^{n} + {G}^{( 0 ) T} {d}_{l}^{n} ) , \qquad ( 8 )$$

$${s}_{2 l + 1}^{n + 1} = {\sum }^{( 1 )} ( {H}^{( 1 ) T} {s}_{l}^{n} + {G}^{( 1 ) T} {d}_{l}^{n} ) . \qquad ( 9 )$$

The wavelet (and also multiwavelet) transformation can be straightforwardly extended to multiple dimensions using tensor product of the bases. For our purpose, a function ƒ∈ [symbol] ^{d} has multiscale, multiwavelet coefficients sₗⁿ, dₗⁿ∈ [symbol] ^{k× . . . ×k×2}^{ⁿ} which are also recursively obtained by replacing the filters in eq. (6)-(7) with their Kronecker product, specifically, H⁽⁰⁾ with H⁽⁰⁾└H⁽⁰⁾⊗ . . . H⁽⁰⁾, where ⊗ is the Kronecker product repeated d times. For eq. (8)-(9)

H⁽⁰⁾Σ⁽⁰⁾ (and similarly others) are replaced with their d-times Kronecker product.

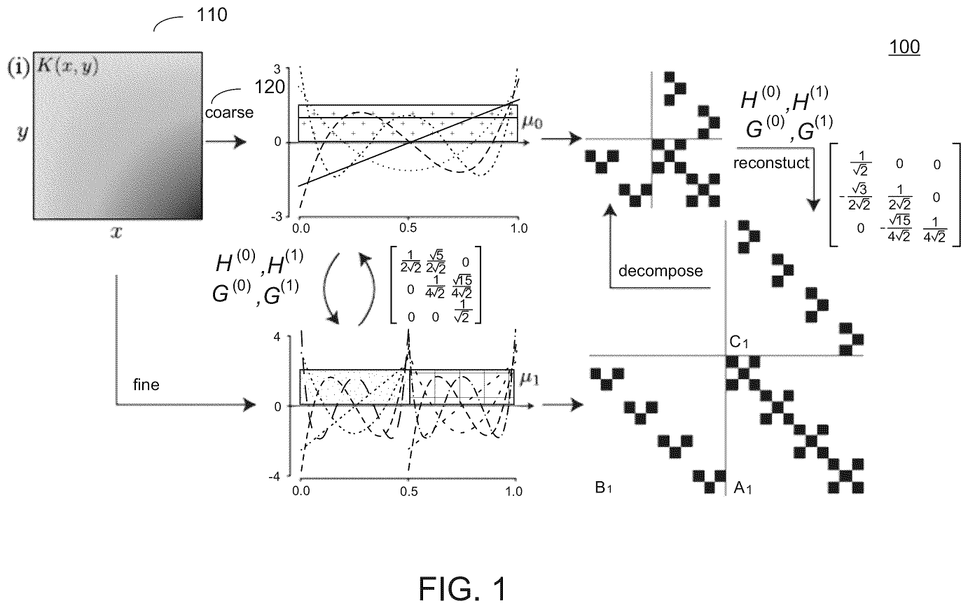

Non-Standard Form: The multiwavelet representation of the operator kernel K (x, y) can be obtained by an appropriate tensor product of the multiscale and multiwavelet basis. One issue, however, in this approach, is that the basis at various scales are coupled because of the tensor product. To untangle the basis at various scales, we use a trick as proposed in called the non-standard wavelet representation. The extra mathematical price paid for the non-standard representation, actually serves as a ground for reducing the proposed model complexity (as described herein), thus, providing data efficiency. For the operator under consideration T with integral kernel K (x, y), let us denote Tₙ as the projection of T on Vₙ^{k}, which is obtained by projecting the kernel K onto basis ∅ⱼₗⁿ w.r.t. measure μₙ. If Pₙ is the projection operator such that Pₙƒ=Σ_{j,l} [symbol] ƒ, ∅ⱼₗⁿ [symbol] _{μ}_{ₙ}∅ⱼₗⁿ, then Tₙ=PₙTPₙ. Using telescopic sum, Tₙ is expanded as

$${T}_{n} = {\sum }_{i = L + 1}^{n} ( {Q}_{i} {TQ}_{i} + {Q}_{i} T {P}_{i - 1} + {P}_{i - 1} {TQ}_{i} ) + {P}_{L} {TP}_{L} , \qquad ( 10 )$$

where, Qᵢ=Pᵢ−Pᵢ₋₁ and L is the coarsest scale under consideration (L≥0). From eq. (3), it is apparent that Qᵢ is the multiwavelet operator. Next, we denote Aᵢ=QᵢTQᵢ, Bᵢ=QᵢTpᵢ₋₁, Cᵢ=Pᵢ₋₁TQᵢ and T̅=P_{L}TP_{L}. In FIG. 1, we show the non-standard multiwavelet transform for a given kernel K (x, y). The transformation has a sparse banded structure due to smoothness property of the kernel (as described herein). For the operator T such that Ta=u, the map under multiwavelet domain is written as

$$\begin{matrix}{U}_{dl}^{n} = {A}_{n} {d}_{l}^{n} + {B}_{n} {S}_{l}^{n} & {U}_{\hat{s} l}^{n} = {C}_{n} {d}_{l}^{n} & {U}_{sl}^{L} = \overline{T} {s}_{l}^{L}\end{matrix} \qquad ( 11 )$$

where, (Uₛₗⁿ, U_{dl}ⁿ)/(sₗⁿ, dₗⁿ) are the multiscale, multiwavelet coefficients of u/a, respectively, and L is the coarsest scale under consideration. With these mathematical concepts, we now proceed to define our multiwavelet-based operator learning model as described herein.

### Multiwavelet-Based Model

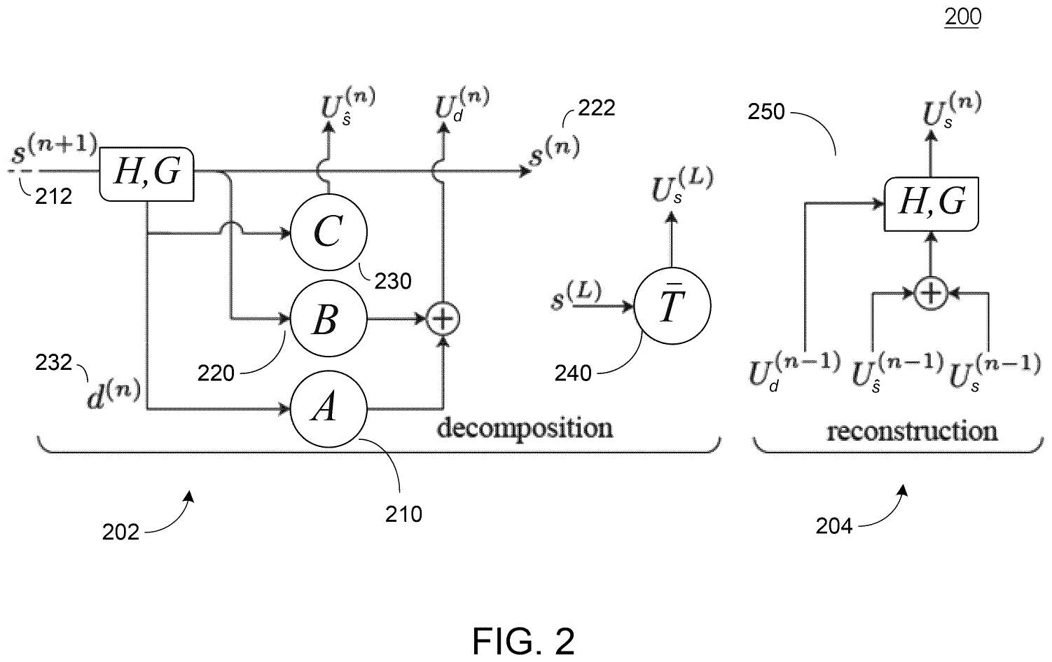

Based on the discussion as described herein, we propose a multiwavelet-based model (MWT) as shown in FIG. 2. For a given input/output as

$$\frac{a}{u} ,$$

the goal of the MWT model is to map the multiwavelet-transform of the input (sₗ^{N}) to output (Uₛₗ^{N}) at the finest scale N. The model includes at least two parts: (i) Decomposition (dec), and (ii) Reconstruction (rec). The dec acts as a recurrent network, and at each iteration the input is sⁿ⁺¹. Using (6)-(7), the input is used to obtain multiscale and multiwavelet coefficients at a coarser level sⁿ and dⁿ, respectively. Next, to compute the multiscale/multiwavelet coefficients of the output u, we approximate the non-standard kernel decomposition from (11) using four neural networks (NNs) A, B, C and T̅ that U_{dl}ⁿ≈A₇₄ _{_{A}}(dₗⁿ)+B₇₄ _{_{B}}(sₗⁿ), Uₛₗⁿ≈C_{θ}_{_{C}}(dₗⁿ), ∀0≤n<L, and Uₛₗ^{L}≈T̅_{θ}_{_{T̅}}(sₗ^{L}). This is a ladder-down approach, and the dec part performs the decimation of signal (factor 1/2), running for a maximum of L cycles, L<log₂(M) for a given input sequence of size M. Finally, the rec module collects the constituent terms Uₛₗⁿ, U_{ŝl}ⁿ, U_{dl}ⁿ (obtained using the dec module) and performs a ladder-up operation to compute the multiscale coefficients of the output at a finer scale n+1 using (8)-(9). The iterations continue until the finest scale Nis obtained for the output.

At each iteration, the filters in dec module downsamples the input, but compared to popular techniques (e.g., maxpool), the input is only transformed to a coarser multiscale/multiwavelet space. By virtue of its design, since the non-standard wavelet representation does not have inter-scale interactions, it basically allows us to reuse the same kernel NNs A, B, C at different scales. A follow-up advantage of this approach is that the model is resolution independent, since the recurrent structure of dec is input invariant, and for a different input size M, only the number of iterations would possibly change for a maximum of log₂ M. The reuse of A, B, C by re-training at various scales also enable us to learn an expressive model with fewer parameters (θ_{A}, θ_{b}, θ_{C}, θ_{T̅}). We see as described herein, that even a single-layered CNN for A, B, C can be used for learning the operator.

The dec/rec module uses the filter matrices which are fixed beforehand, therefore, this part may not utilize training processes. The model does not work for any arbitrary choice of fixed matrices H, G. We show as described herein that for randomly selected matrices, the model does not learn, which validates that careful construction of filter matrices may be necessary.

### Operators Properties

This section outlines definition of the integral kernels that are useful in an efficient compression of the operators through multiwavelets. We then discuss a fundamental property of the pseudo-differential operator.

Definition 1. Calderón-Zygmund Operator. The integral operators that have kernel K(x, y) which is smooth away from the diagonal, and satisfy the following.

$$\vert K ( x , y ) \vert \leq \frac{1}{\vert x - y \vert} , \qquad ( 12 )$$

$$\vert {ϑ}_{x}^{M} K ( x , y ) \vert + \vert {ϑ}_{y}^{M} K ( x , y ) \vert \leq \frac{{C}_{0}}{{\vert x - y \vert}^{M + 1}} .$$

The smooth functions with decaying derivatives are gold to the multiwavelet transform. Note that, smoothness implies Taylor series expansion, and the multiwavelet transform with sufficiently large k zeroes out the initial k terms of the expansion due to vanishing moments property (5). This is how multiwavelet sparsifies the kernel (see FIG. 1 where K(x+y) is smooth). Although, the definition of Calderón-Zygmund is simple (singularities only at the diagonal), but the multiwavelets are capable to compresses the kernel as long as the number of singularities are finite.

The next property, from, points out that with input/output being single-dimensional functions, for any pseudo-differential operator (with smooth coefficients), the singularity at the diagonal is also well-characterized.

Property 1. Smoothness of Pseudo-Differential Operator. For the integral kernel K(x, y) of a pseudo-differential operator, K(x, y)∈C^{∞}∀x≠y, and ƒ or x=y, K(x, y)∈C^{T-1}, where T+1 is the highest derivative order in the given pseudo-differential equation.

The property 1 implies that, for the class of pseudo-differential operator, and any set of basis with the initial J vanishing moments, the projection of kernel onto such bases will have the diagonal dominating the non-diagonal entries, exponentially, if J>T−1[21]. For the case of multiwavelet basis with k OPs, J=k (from eq. (5)). Therefore, k>T−1 sparsifies the kernel projection onto multiwavelets, for a fixed number of bits precision ϵ. We see the implication of the Property 1 on our proposed model as described herein.

### Empirical Evaluation

In this section, we evaluate the multiwavelet-based model (MWT) on several PDE datasets. We show that the proposed MWT model not only exhibits orders of magnitude higher accuracy when compared against the state-of-the-art (Sota) approaches but also works consistently well under different input conditions without parameter tuning. From a numerical perspective, we take the data as point-wise evaluations of the input and output functions. Specifically, we have the dataset (aᵢ, uᵢ) with aᵢ=a(xᵢ), uᵢ=u(uᵢ) for x₁, x₂, . . . , x_{N}∈D, where xᵢ are M-point discretization of the domain D. Unless stated otherwise, the training set is of size 1000 while test is of size 200.

Model architectures: Unless otherwise stated, the NNs A, B and (' in the proposed model (FIG. 2) are chosen as a single-layered CNNs following a linear layer, while T̅ is taken as single k×k linear layer. We choose k=4 in all our experiments, and the OP basis as Legendre (Leg), Chebyshev (Chb) with uniform, non-uniform measure μ₀, respectively. The model in FIG. 2 is treated as single layer, and for 1D equations, we cascade 2 multiwavelet layers, while for 2D dataset, we use a total 4 layers with ReLU non-linearity.

From a mathematical viewpoint, the dec and rec modules in FIG. 2 transform only the multiscale and multiwavelet coefficients. However, the input and output to the model are point-wise function samples, e.g., (aᵢ, uᵢ). A remedy around this is to take the data sequence, and construct functions ƒₐ=Σᵢ₌₁^{N}aᵢϕⱼᵢⁿ and ƒᵤ=Σᵢ₌₁^{N}uᵢϕⱼᵢⁿ. Clearly, ƒₐ, ƒᵤ lives in Vₙ^{k} with n=log₂N. Now the model can be used with s⁽ⁿ⁾=aᵢ and Uₛ⁽ⁿ⁾=uᵢ. Note that ƒₐ, ƒᵤ are not explicitly used, but only a matter of convention.

Benchmark models: We compare our MWT model using two different OP basis (Leg, Chb) with other neural operators. Specifically, we consider the graph neural operator (GNO), the multipole graph neural operator (MGNO), the LNO which makes a low-rank (r) representation of the operator kernel K(x, y) (also similar to unstacked DeepONet), and the Fourier neural operator (FNO). We experiment on three competent datasets setup by the work of FNO (Burgers' equation (1-D), Darcy Flow (2-D), and Navier-Stokes equation (time-varying 2-D)). In addition, we also experiment with Korteweg-de Vries equation (1-D). For the 1-D cases, a modified FNO with careful parameter selection and removal of Batch-normalization layers results in a better performance compared with the original FNO, and we use it in our experiments. The MWT model demonstrates the highest accuracy in all the experiments. The MWT model also shows the ability to learn the function mapping through lower-resolution data, and able to generalize to higher resolutions.

TABLE 1
Korteweg-de Vries (KdV) equation benchmarks for different
input resolution s. Top: Our methods. Bottom:
previous works of Neural operator.

| Networks | s = 64 | s = 128 | s = 256 | s = 512 | s = 1024 |
|---|---|---|---|---|---|
| MWT Leg | 0.00338 | 0.00375 | 0.00418 | 0.00393 | 0.00389 |
| MWT Cheb | 0.00715 | 0.00712 | 0.00604 | 0.00769 | 0.00675 |
| FNO | 0.0125 | 0.0124 | 0.0125 | 0.0122 | 0.0126 |
| MGNO | 0.1296 | 0.1515 | 0.1355 | 0.1345 | 0.1363 |
| LNO | 0.0429 | 0.0557 | 0.0414 | 0.0425 | 0.0447 |
| GNO | 0.0789 | 0.0760 | 0.0695 | 0.0699 | 0.0721 |

All the models (including ours) are trained for a total of 500 epochs using Adam optimizer with an initial learning rate (LR) of 0.001. The LR decays after every 100 epochs with a factor of y=0.5. The loss function is taken as relative L2 error. All of the experiments are performed on a single Nvidia V100 32 GB GPU, and the results are averaged over a total of 3 seeds.

### 3.1 Korteweg-de Vries (KdV) Equation

The Korteweg-de Vries (KdV) equation was first proposed by Boussinesq and rediscovered by Korteweg and de Vries [25]. KdV is a 1-D non-linear PDE that may be used to describe the non-linear shallow water waves. For a given field u(x, t), the dynamics takes the following form:

$$\frac{\partial u}{\partial t} = - 0.5 u \frac{\partial u}{\partial x} - \frac{{\partial }^{3} u}{\partial {x}^{3}} , x ∈ ( 0 , 1 ) , t ∈ ( 0 , 1 ] \qquad ( 13 )$$

$${u}_{0} ( x ) = u ( x , t = 0 )$$

The task for the neural operator is to learn the mapping of the initial condition u₀(x) to the solutions u(x, t=1). We generate the initial condition in Gaussian random fields according to u₀˜ [symbol] (0, 7⁴(−Δ+7²I)^{-2.5}) with periodic boundary conditions. The equation is numerically solved using chebfun package [29] with a resolution 2¹⁰, and datasets with lower resolutions are obtained by sub-sampling the highest resolution data set.

Varying resolution: The experimental results of the Kdv equation for different input resolutions s are shown in Table 1. We see that, compared to any of the benchmarks, our proposed MWT Leg exhibits the lowest relative error and is lowest nearly by an order of magnitude. Even in the case of the resolution of 64, the relative error is low, which means that a sparse data set with a coarse resolution of 64 is can be used for the neural operator to learn the function mapping between infinite-dimensional spaces.

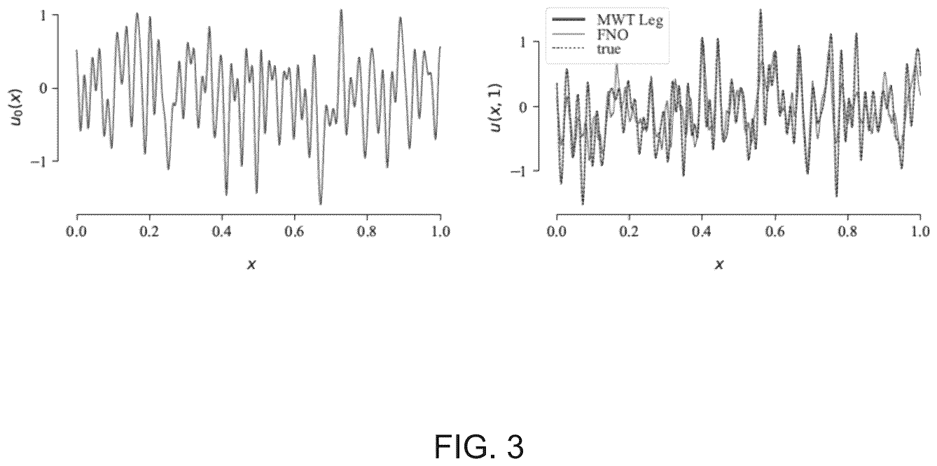

Varying fluctuations: We now vary the smoothness of the input function u₀(x, 0) by controlling the parameter λ, where low values of λ imply more frequent fluctuations and λ→0 reaches the Brownian motion limit. To isolate the importance of incorporating the multiwavelet transformation, we use the same convolution operation as in FNO, e.g., Fourier transform-based convolution with different modes kₘ (only single-layer) for A, B, C. We see in FIG. 3 that MWT model consistently outperforms the recent baselines for all the values of λ. A sample input/output from test set is shown in the FIG. 3. The FNO model with higher values of kₘ has better performance due to more Fourier bases for representing the high-frequency signal, while MWT does better even with low modes in its A, B, C CNNs, highlighting the importance of using wavelet-based filters in the signal processing.

### 3.2 Theoretical Properties Validation

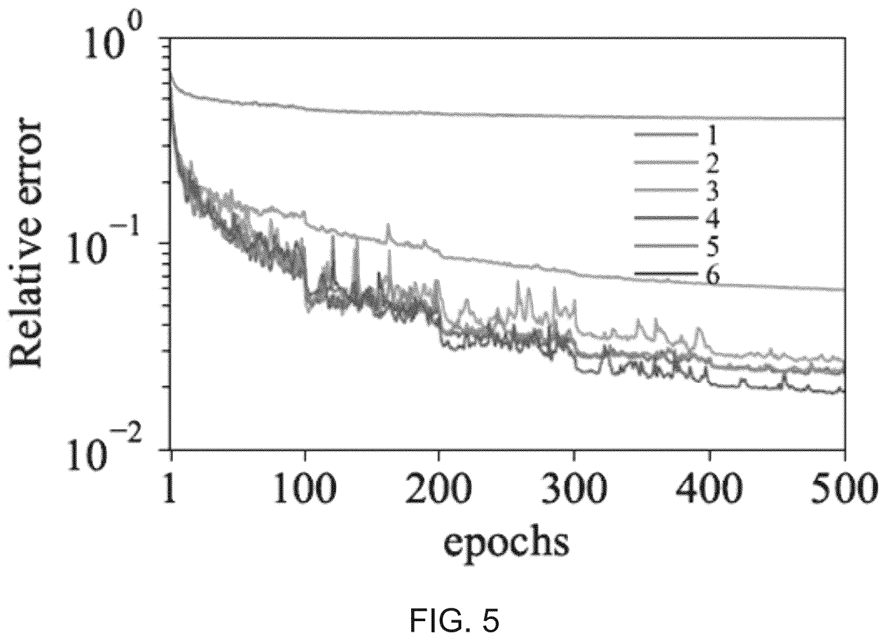

We test the ability of the proposed MWT model to capture the theoretical properties of the pseudo-differential operator in this section. Towards that, we consider the Euler-Bernoulli equation that models the vertical displacement of a finite length beam over time. A Fourier transform version of the beam equation with the constraint of both ends being clamped is as follows

$$\begin{matrix}\frac{{\partial }^{4} u}{\partial x} - {ω}^{2} u = f ( x ) , & \frac{\partial u}{\partial x}\end{matrix} {\vert}_{\begin{matrix}x = 1 \\ x = 0\end{matrix}} = 0 \qquad ( 14 )$$

$$u ( 0 ) = u ( 1 ) = 0 ,$$

where u(x) is the Fourier transform of the time-varying beam displacement, ω is the frequency, ƒ(x) is the applied force. The Euler-Bernoulli is a pseudo-differential equation with the maximum derivative order T+1=4. We take the task of learning the map from ƒ to u. In FIG. 5, we see that for k≥3, the models relative error across epochs is similar, however, they are different for k<3, which is in accordance with the Property 1. For k<3, the multiwavelets will not be able to annihilate the diagonal of the kernel which is C^{T-1}, hence, sparsification cannot occur, and the model learns slow.

### 3.3 Burgers' Equation

The 1-D Burgers' equation is a non-linear PDE occurring in various areas of applied mathematics. For a given field u(x, t) and diffusion coefficient v, the 1-D Burgers' equation reads:

$$\frac{\partial u}{\partial t} = - u \frac{\partial u}{\partial x} + v \frac{{\partial }^{2} u}{\partial {x}^{2}} , \qquad ( 15 )$$

$$x ∈ ( 0 , 2 π ) ,$$

$$t ∈ ( 0 , 1 ]$$

$${u}_{0} ( x ) = u ( x , t = 0 ) .$$

The task for the neural operator is to learn the mapping of initial condition u(x, t=0) to the solutions at t=1 u(x, t=1). To compare with many advanced neural operators under the same conditions, we use the Burgers' data and results. The initial condition is sampled as Gaussian random fields where u₀˜ [symbol] (0, 5⁴(−Δ+5²1)⁻²) with periodic boundary conditions. A is the Laplacian, meaning the initial conditions are sampled by sampling its first several coefficients from a Gaussian distribution. In the Burgers' equation, v is set to 0.1. The equation is solved with resolution 2¹³, and the data with lower resolutions are obtained by sub-sampling the highest resolution data set.

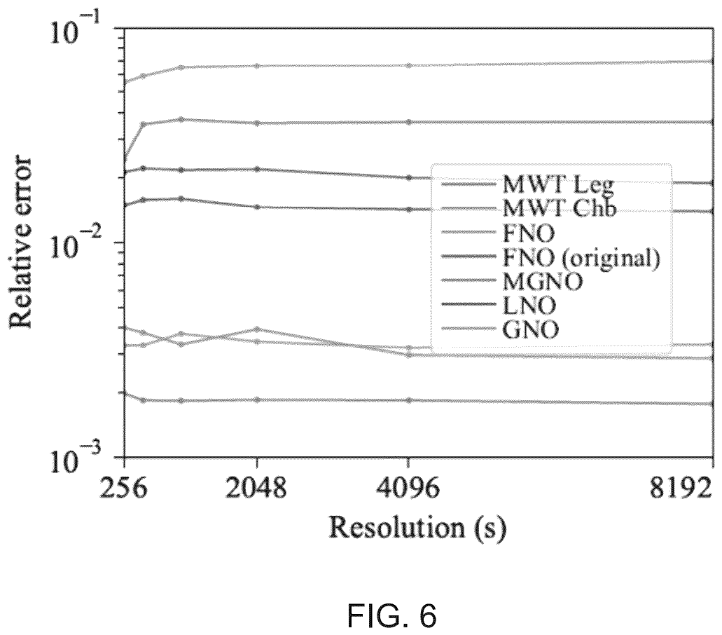

The results of the experiments on Burgers' equation for different resolutions are shown in FIG. 6. Compared to any of the benchmarks, our MWT Leg obtains the lowest relative error, which is an order of magnitude lower than the state-of-the-art. It's worth noting that even in the case of low resolution, MWT Leg still maintains a very low error rate, which shows its potential for learning the function mapping through low-resolution data, that is, the ability to map between infinite-dimensional spaces by learning a limited finite-dimensional spaces mapping.

TABLE 2
Benchmarks on Darcy Flow equation at various input resolution
s. Top: Our methods. MWT Rnd instantiate random entries of the
filter matrices in (6)-(9). Bottom: prior works on Neural operator.

| Networks | s = 32 | s = 64 | s = 128 | s = 256 | s = 512 |
|---|---|---|---|---|---|
| MWT Leg | 0.0152 | 0.00899 | 0.00747 | 0.00722 | 0.00654 |
| MWT Chb | 0.0174 | 0.0108 | 0.00872 | 0.00892 | 0.00891 |
| MWT Rnd | 0.2435 | 0.2434 | 0.2434 | 0.2431 | 0.2432 |
| FNO | 0.0177 | 0.0121 | 0.0111 | 0.0107 | 0.0106 |
| MGNO | 0.0501 | 0.0519 | 0.0547 | 0.0542 | — |
| LNO | 0.0524 | 0.0457 | 0.0453 | 0.0428 | — |

### 3.4 Darcy Flow

Darcy flow formulated by Darcy is one of the basic relationships of hydrogeology, describing the flow of a fluid through a porous medium. We experiment on the steady-state of the 2-d Darcy flow equation on the unit box, where it takes the following form:

$$∇ \cdot ( a ( x ) ∇ u ( x ) ) = f ( x ) , \qquad ( 16 )$$

$$x ∈ {( 0 , 1 )}^{2}$$

$$u ( x ) = 0 ,$$

$$x ∈ \partial {( 0 , 1 )}^{2}$$

We set the experiments to learn the operator mapping the coefficient a(x) to the solution u(x). The coefficients are generated according to a α˜ [symbol] (0,(−Δ+3²I)⁻²), where Δ is the Laplacian with zero Neumann boundary conditions. The threshold of a (x) is set to achieve ellipticity. The solutions u(x) are obtained by using a 2nd-order finite difference scheme on a 512×512 grid. Data sets of lower resolution are sub-sampled from the original data set.

The results of the experiments on Darcy Flow for different resolutions are shown in Table2. MWT Leg again obtains the lowest relative error compared to other neural operators at various resolutions. We also perform an additional experiment, in which the multiwavelet filters H⁽ⁱ⁾, G⁽ⁱ⁾, i=0,1 are replaced with random values (properly normalized). We see in Table 2, that MWT Rnd does not learn the operator map, in fact, its performance is worse than all the models. This signifies the importance of the careful choice of the filter matrices.

### 3.5 Additional Experiments

Full results for these experiments are provided in the supplementary materials.

Navier Stokes Equation: The Navier-Stokes (NS) are 2d time-varying PDEs modeling the viscous, incompressible fluids. The proposed MWT model does a 2d multiwavelet transform for the velocity u, while uses a single-layered 3d convolution for A, B and C to learn dependencies across space-time. We have observed that the proposed MWT Leg is in par with the Sota on the NS equations in Appendix D.1.

Prediction at high resolution: We show that MWT model trained at lower resolutions for various datasets (for example, training with s=256 for Burgers) can predict the output at finer resolutions s=2048, with relative error of 0.0226, thus eliminating the need for expensive sampling. The training and testing with s=2048 yields a relative error of 0.00189. The full experiment is discussed in Appendix D.2.

Train/evaluation with different sampling rules: We study the operator learning behavior when the training and evaluation datasets are obtained using random function from different generating rules. In Appendix D.4.2, the training is done with squared exponential kernel but evaluation is done on different generating rule with controllable parameter λ.

### Conclusion

We address the problem of data-driven learning of the operator that maps between two function spaces. Motivated from the fundamental properties of the integral kernel, we found that multiwavelets constitute a natural basis to represent the kernel sparsely. After generalizing the multiwavelets to work with arbitrary measures, we proposed a series of models to learn the integral operator. These techniques may be used to design efficient Neural operators utilizing properties of the kernels, and the suitable basis. These techniques may be used to solve many engineering and biological problems such as aircraft wing design, complex fluids dynamics, metamaterials design, cyber-physical systems, neuron-neuron interactions that are modeled by complex PDEs.

### Wavelets

The wavelets represent sets of functions that result from dilation and translation from a single function, often termed as ‘mother function’, or ‘mother wavelet’. For a given mother wavelet ψ(x), the resulting wavelets are written as

$${ψ}_{a , b} ( x ) = \frac{1}{{\vert a \vert}^{1 / 2}} ψ ( \frac{x - b}{a} ) , \qquad ( 17 )$$

$$a , b ∈ ℝ , a \neq 0 , x ∈ D ,$$

where a, b are the dilation, translation factor, respectively, and D is the domain of the wavelets under consideration. We are interested in the compactly supported wavelets, or D is a finite interval [l, r], and we also take ψ∈L². The consideration for non-compact wavelets, for example, will be a future consideration. Without loss of generality, we provide examples that utilize the finite domain D=[0,1], and extension to any [l, r] can be simply done by making suitable shift and scale.

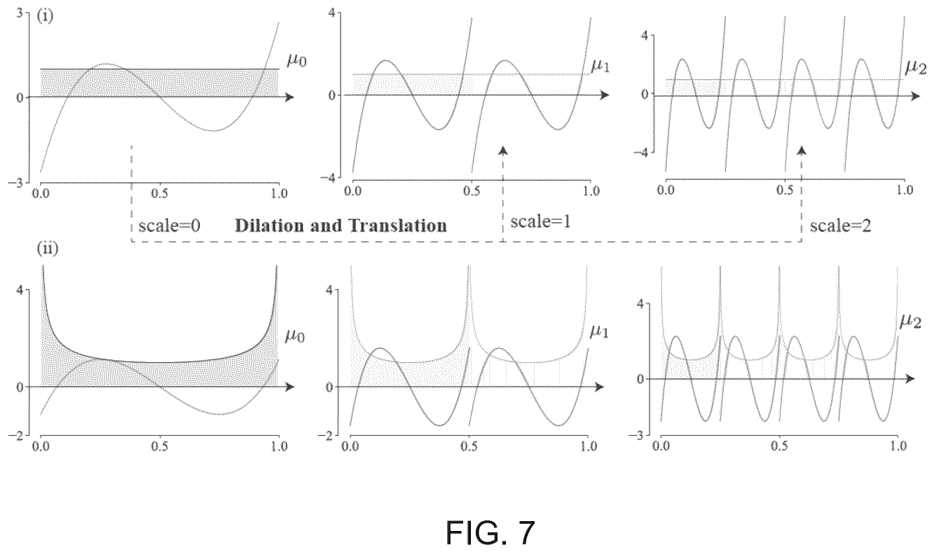

From a numerical perspective, discrete values (or Discrete Wavelet Transform) of a, b are more useful, and hence, we take a a=2^{-j}, j=0,1, . . . , L−1, where L are the finite number of scales up to which the dilation occurs, and the dilation factor is 2. For a given value of a=2^{-j}, the values of b can be chosen as, b=na, n=0,1, . . . , 2−1. The resulting wavelets are now expressed as ψ_{j,n}(x)=2^{j/2}ψ(2^{j}x−n), n=0,1, . . . 2^{j}−1, and x∈[n2^{-j}, (n+1)2^{-j}]. Given a mother wavelet function, the dilation and translation operations for three scales (L=3) is shown in FIG. 7. For a given function ƒ, the discrete wavelet transform is obtained by projecting the function ƒ onto the wavelets ψ_{j,n} as

$${c}_{j , n} = {\int }_{n {2}^{- j}}^{( n + 1 ) {2}^{- j}} f ( x ) {ψ}_{j , n} dx , \qquad ( 18 )$$

where c_{j,n} are the discrete wavelet transform coefficients.

### Orthogonal Polynomials

The next set of ingredients that are useful to us are the family of orthogonal polynomials (OPs). Specifically, the OPs in the present disclosure will serve as the mother wavelets or span the ‘mother subspace’. Therefore, we are interested in the OPs that are non-zero over a finite domain, and are zero almost everywhere (a.e.). For a given measure μ that defines the OPs, a sequence of OPs P₀(x), P₁(x), . . . satisfy deg(Pᵢ)=i, and [symbol] Pᵢ, Pⱼ [symbol] _{μ}=0, ∀i≠j where [symbol] Pᵢ, Pⱼ [symbol] _{μ}=∫Pᵢ(x)Pⱼ(x)dμ. Therefore, sequence of OPs are useful as they can act as a set of basis for the space of polynomials with degree<d by using P₀, . . . , P_{d-1}(x).

The popular set of OPs are hypergeometric polynomials (also known as Jacobi polynomials). Among them, the common choices are Legendre, Chebyshev, and Gegenbauer (which generalize Legendre and Chebyshev) polynomials. These polynomials are defined on a finite interval of [−1,1] and are useful for the techniques described herein. The other set of OPs are Laguerre, and Hermite polynomials which are defined over non-finite domain. Such OPs can be used to extend the present techniques to non-compact wavelets. We now review some defining properties of the Legendre and Chebyshev polynomials.

### Legendre Polynomials

The Legendre polynomials are defined with respect to (w.r.t.) a uniform weight function W_{L}(x)=1 for −1≤x≤1 or W_{L}(x)=1_{[-1,1]}(x) such that

$${\int }_{- 1}^{1} {P}_{i} ( x ) {P}_{j} ( x ) dx = \{ \begin{matrix}\frac{2}{2 i + 1} & i = j , \\ 0 & i \neq j\end{matrix} . \qquad ( 19 )$$

For our purpose, we shift and scale the Legendre polynomials such that they are defined over [0,1] as Pᵢ(2x−1), and the corresponding weight function as w_{L}(2x−1).

Derivatives: The Legendre polynomials satisfy the following recurrence relationships

$${iP}_{i} ( x ) = ( 2 i - 1 ) {xP}_{i - 1} ( x ) - ( i - 1 ) {P}_{i - 2} ( x ) ,$$

$$( 2 i + 1 ) {P}_{i} ( x ) = {P}_{i + 1}^{′} ( x ) - {P}_{i - 1}^{′} ( x ) ,$$

which allow us to express the derivatives as a linear combination of lower-degree polynomials itself as follows: . . .

$${P}_{i}^{′} ( x ) = ( 2 i - 1 ) {P}_{i - 1} ( x ) + ( 2 i - 3 ) {P}_{i - 1} ( x ) + … , \qquad ( 2 )$$

where the summation ends at either P₀(x) or P₁(x), with P₀(x)=1 and P₁(x)=x.

Basis: A set of orthonormal basis of the space of polynomials with degree<d defined over the interval [0,1] is obtained using shifted Legendre polynomials such that

$${ϕ}_{i} = \sqrt{2 i + 1} {P}_{i} ( 2 x - 1 ) ,$$

w.r.t. weight function w(x)=w_{L}(2x−1), such that

$${〈 {ϕ}_{i} , {ϕ}_{j} 〉}_{μ} = {\int }_{0}^{1} {ϕ}_{i} ( x ) {ϕ}_{j} ( x ) dx = {δ}_{ij}$$

### Chebyshev Polynomials

The Chebyshev polynomials are two sets of polynomial sequences (first, second order) as Tᵢ, Uᵢ. We take the polynomial of the first order Tᵢ(x) of degree i which is defined w.r.t. weight function w_{Ch}(x)=1/\sqrt{1−x²} for −1≤x≤1 as

$${\int }_{- 1}^{1} {T}_{i} ( x ) {T}_{j} ( x ) \frac{1}{\sqrt{1 - {x}^{2}}} dx = \{ \begin{matrix}π & i = j = 0 , \\ π / 2 & i = j > 0 , \\ 0 & i \neq j\end{matrix} . \qquad ( 21 )$$

After applying the scale and shift to the Chebyshev polynomials such that their domain is limited to [0,1], we get Tᵢ(2x−1) and the associated weight function as w_{Ch}(2x−1) such that Tᵢ(2x−1) are orthogonal w.r.t. w_{Ch}(2x−1) over the interval [0,1].

Derivatives: The Chebyshev polynomials of the first order satisfy the following recurrence relationships

$$2 {T}_{i} ( x ) = \frac{1}{i + 1} {T}_{i + 1}^{′} ( x ) - \frac{1}{i + 1} {T}_{i + 1}^{′} ( x ) , i > 1 ,$$

$${T}_{i + 1} ( x ) = 2 {xT}_{i} ( x ) - {T}_{i - 1} ( x ) ,$$

The derivative of the Tᵢ(x) can be written as the following summation of sequence of lower degree polynomials

$${T}_{i}^{′} ( x ) = i ( 2 {T}_{i - 1} ( x ) + 2 {T}_{i - 3} ( x ) + … ) ,$$

where the series ends at either T₀(x)=1, or T₁(x)=x. Alternatively, the derivative of Tᵢ(x) can also be written as T′ᵢ(x)=iUᵢ₋₁(x), where Uᵢ(x) is the second-order Chebyshev polynomial of degree i.

Basis: A set of orthonormal basis of the space of polynomials of degree up to d and domain [0,1] is obtained using Chebyshev polynomials as

$${ϕ}_{i} = \{ \begin{matrix}\frac{2}{\sqrt{π}} {T}_{i} ( 2 x - 1 ) & i > 0 , \\ \sqrt{\frac{2}{π}} & i = 0\end{matrix} .$$

w.r.t. weight function w_{Ch}(2x−1), or

$${〈 {ϕ}_{i} , {ϕ}_{j} 〉}_{μ} = {\int }_{0}^{1} {ϕ}_{i} ( x ) {ϕ}_{j} ( x ) {w}_{Cb} ( 2 x - 1 ) dx = {δ}_{ij} .$$

Roots: Another useful property of Chebyshev polynomials is that they can be expressed as trigonometric functions; specifically, Tₙ(cos θ)=cos(nθ). The roots of such are also well-defined in the interval [−1,1]. For Tₙ(x), the n roots x₁, . . . , xₙ are given by

$${x}_{i} = cos ( \frac{π}{n} ( i - \frac{1}{2} ) ) .$$

### Multiwavelets

The multiwavelets can exploit the advantages of both wavelets, as well as OPs, as described herein. For a given function ƒ, instead of projecting the function onto a single wavelet function (wavelet transform), the multiwavelets go one step further and projects the function onto a subspace of degree-restricted polynomials. Along the essence of the wavelet- transform, in multiwavelets, a sequence of wavelet bases are constructed which are a scaled/shifted version of the basis of the coarsest scale polynomial subspace.

We present a measure-version of the multiwavelets which opens-up a family of the multiwavelet-based models for the operator learning. Below, we provide a detailed mathematical formulation for developing multiwavelets using any set of OPs with measures which can be non-uniform. To be able to develop compactly supported multiwavelets, we have restricted ourself to the family of OPs which are non-zero only over a finite interval. The extension to non-compact wavelets could be done by using OPs which are non-zero over complete/semi range of the real-axis (for example, Laguerre, Hermite polynomials). As an example, we present the expressions for Legendre polynomials which use uniform, as described herein, and Chebyshev polynomials which use non-uniform, as described herein. These techniques can be readily extended to other family of OPs like Gegenbauer polynomials.

### Pseudo-Differential Equations

The linear inhomogeneous pseudo-differential equations [symbol] =ƒ have the operator which takes the following form

$$ℒ = {\sum }_{α ∈ 𝔸} {a}_{α} ( x ) {\partial }_{x}^{α} , \qquad ( 22 )$$

where A is the subset of natural numbers [symbol] ∪{0}, and x∈ [symbol] ⁿ. The order of the equation is denoted by the highest integer in the set [symbol] . The simplest and the most useful case of pseudo-differential operators [symbol] is the one in which aₐ(x)∈C^{∞}. In the pseudo-differential operators literature, it is often convenient to have a symbolic representation for the pseudo-differential operator. First, the Fourier transform of a function ƒ is taken as \hat{ƒ}(ξ)= [symbol] ƒ(x)e^{-i2πξx} dx. The pseudo-differential operator over a function ƒ is defined as

$${T}_{a} f ( x ) = {\int }_{{ℝ}^{n}} a ( x , ξ ) {e}^{i 2 π ξ x} \hat{f} ( x ) dx ,$$

where the operator Tₐ is parameterized by the symbol a (x, ξ) which for the differential equation (22) is given by

$$a ( x , ξ ) = {\sum }_{α ∈ 𝔸} {a}_{α} ( x ) {( 2 π i ξ )}^{α} .$$

The Euler-Bernoulli equation as discussed herein has [symbol] ={0,4}.

### Multiwavelet Filters

Below, we discuss in detail the multiwavelet filters as presented herein. First, we introduce some mathematical terminologies that are useful for multiwavelets filters and then preview a few useful tools.

### Measures, Basis, and Projections

Measures: The functions are expressed w.r.t. basis usually by using measures u which could be non-uniform in-general. Intuitively, the measure provides weights to different locations over which the specified basis are defined. For a measure μ, let us consider a Radon-Nikodym derivative as

$$w ( x ) := \frac{d μ}{d λ} ( x ) ,$$

where dλ:=dx is the Lebesgue measure. In other words, the measure-dependent integrals ∫ƒdμ(x), can now be defined as ∫ƒ(x)w(x)dx.

Basis: A set of orthonormal basis w.r.t. measure μ, are ϕ₀, . . . , ϕₖ₋₁ such that [symbol] ϕᵢ, ϕⱼ [symbol] _{μ}=δᵢⱼ. With the weighting function w(x), which is a Radon-Nikodym derivative w.r.t. Lebesgue measure, the orthonormality condition can be re-written as ∫ϕᵢ(x)ϕⱼ(x)w(x)dx=δᵢⱼ.

The basis can also be appended with a multiplicative function called tilt X(x) such that for a set of basis ϕᵢ which is orthonormal w.r.t. μ with weighting function

$$\frac{d μ}{d λ} ( x ) = w ( x ) ,$$

a new set of basis ϕᵢX are now orthonormal w.r.t. a measure having weighting function w/X². We will see that for OPs like Chebyshev, as discussed herein, a proper choice of tilt X(x) simplifies the analysis.

Projections: For a given set of basis ϕᵢ defined w.r.t. measure μ and corresponding weight function w(x), the inner-products are defined such that they induce a measure-dependent Hilbert space structure [symbol] . Next, for a given function ƒ such that ƒ∈ [symbol] , the projections onto the basis polynomials are defined as cᵢ=∫ƒ(x)ϕᵢ(x)w(x)dx.

### Gaussian Quadrature

The Gaussian quadrature are the set of tools which are useful in approximating the definite integrals of the following form

$${\int }_{a}^{b} f ( x ) w ( x ) dx \approx {\sum }_{i = 1}^{n} {ω}_{i} f ( {x}_{i} ) \qquad ( 23 )$$

where, wᵢ are the scalar weight coefficients, and xᵢ are the n locations chosen appropriately. For an-point quadrature, the eq. (23) is exact for the functions ƒ that are polynomials of degree≤2n−1. This is useful, as we will see below.

From the result in [64], it can be argued that, for a class of OPs Pᵢ defined w.r.t. weight function w(x) over the interval [a, b] such that x₁, x₂, . . . , xₙ are the roots of Pₙ, if

$${\sum }_{i = 1}^{n} {ω}_{i} {P}_{k} ( {x}_{i} ) = \{ \begin{matrix}{‖ {P}_{0} ‖}_{μ}^{2} & k = 0 , \\ 0 & k > 0\end{matrix} ,$$

then,

$${\sum }_{i = 1}^{n} {ω}_{i} f ( {x}_{i} ) = {\int }_{a}^{b} f ( x ) w ( x ) dx ,$$

for any ƒ such that ƒ is a polynomial of degree≤2n−1. The weight coefficients can also be written in a closed-form expression [1] as follows

$${ω}_{i} = \frac{{a}_{n}}{{a}_{n - 1}} \frac{{\int }_{a}^{b} {P}_{n - 1}^{2} ( x ) w ( x ) dx}{{P}_{n}^{′} ( {x}_{i} ) {P}_{n - 1} ( {x}_{i} )} , \qquad ( 24 )$$

where, an is the coefficient of xⁿ in Pₙ. Thus, the integral in (23) can be computed using family of OPs defined w.r.t. weight function w(x). Depending on the class of OPs chosen, the Gaussian quadrature formula can be derived accordingly using eq. (24). For a common choice of OPs, the corresponding name for the Quadrature is ‘Gaussian-Legendre’, ‘Gaussian-Chebyshev’, ‘Gaussian-Laguerre’, etc.

### Gram-Schmidt Orthogonalization

The Gram-Schmidt Orthogonalization (GSO) is a common technique for deriving a (i) set of vectors in a subspace, orthogonal to an (ii) another given set of vectors. We briefly write the GSO procedure for obtaining a set of orthonormal polynomials w.r.t. measures which in-general is different for polynomials in set (i) and (ii). We consider that for a given subspace of polynomials with degree<k as V₀ and another subspace of polynomials with degree<k V₁, such that V₀⊂V₁, we wish to obtain a set of orthonormal basis for the subspace of polynomials with degree<k W₀, such that V₀⊥W₀ and W₀⊂V₁. It is apparent that, if dim(W₀)=n, dim(V₀)=m and dim(V₁)=p, then m+n≤p.

Let (ψ₀, . . . , ψₙ₋₁) be a set of basis of the polynomial subspace W₀, (₀⁽⁰⁾, . . . , ϕₘ₋₁⁽⁰⁾) be a set of basis for V₀, and (ϕ₁⁽⁰⁾, . . . , ϕₚ₋₁⁽¹⁾) be a set of basis for V₁. We take that basis ψ₁ and ϕ₁⁽⁰⁾ are defined w.r.t. same measure μ₀, while ϕᵢ⁽¹⁾ are defined w.r.t. a different measure μ₁. A set of ψᵢ can be obtained by iteratively applying the following procedure for i=0,1, . . . , n−1

$${ψ}_{i} ← {ϕ}_{i}^{( 1 )} - {\sum }_{j = 0}^{m - 1} {〈 {ϕ}_{i}^{( 1 )} , {ϕ}_{j}^{( 0 )} 〉}_{{μ}_{0}} {ϕ}_{j}^{( 0 )} - {\sum }_{l = 0}^{i - 1} {〈 {ϕ}_{i}^{( i )} , {ψ}_{l} 〉}_{{μ}_{0}} {ψ}_{l} , \\ {ψ}_{i} ← \frac{{ψ}_{i}}{{‖ {ψ}_{i} ‖}_{{μ}_{0}}} . \qquad ( 25 )$$

The procedure in (25) results in a set of orthonormal basis of W₀ such that [symbol] ψᵢ, ψⱼ [symbol] _{μ}_{₀}=δᵢⱼ as well as [symbol] ψᵢ, ϕⱼ⁽⁰⁾ [symbol] _{μ}_{₀}, ∀0≤i<n, 0≤j<m. We will see below that the inner-product integrals in eq. (25) can be efficiently computed using the Gaussian Quadrature formulas (as discussed herein).

### Derivations for Multiwavelet Filters

Using the mathematical preliminaries and tools discussed previously herein, we are now in shape to present a detailed derivations for the measure dependent multiwavelet filters. We start with deriving the general filters expressions. Expressions for Legendre polynomials then for Chebyshev polynomials are presented below.

### Filters as Subspace Projection Coefficients

The ‘multiwavelet filters’ play the role of transforming the multiwavelet coefficients from one scale to another. Let us revisit the Section 2.2, where we defined a space of piecewise polynomial functions, for k∈ [symbol] and n∈ [symbol] ⁺∪{0} as, Vₙ^{k}. The dim(Vₙ^{k})=2ⁿk, and for subsequent n, each subspace is contained in another, e.g., Vₙ₋₁^{k}⊂dependent ₙ^{k}. Now, if ϕ₀, . . . , ϕₖ₋₁ are a set of basis polynomials for V₀^{k} w.r.t. measure μ₀, then we know that a set of basis for V₁^{k} can be obtained by scale and shift of ϕᵢ as ϕⱼₗ=2^{1/2}ϕⱼ(2x−l)l=0,1, and the measure accordingly as μ₁. For a given function ƒ, its multiwavelet coefficients for projections over V₀^{k} are taken as s₀ᵢ⁰= [symbol] ƒ, ϕᵢ [symbol] )μ₀ and for V₁^{k} is taken as sₗᵢ¹= [symbol] ƒ, ϕᵢₗ¹ [symbol] _{μ}_{₁}, and, we are looking for filter coefficients (H) such that a transformation between projections at these two consecutive scale exists, or

$${s}_{0 i}^{0} = {\sum }_{l = 0 , 1} {\sum }_{j = 0}^{k - 1} {H}_{ij}^{( l )} {s}_{lj}^{1} . \qquad ( 26 )$$

Let us begin by considering a simple scenario. Since, V₀^{k}⊂V₁^{k}, the basis are related as

$${ϕ}_{i} = {\sum }_{j = 0}^{k - 1} {α}_{ij}^{( 0 )} \sqrt{2} {ϕ}_{j} ( 2 x ) + {\sum }_{j = 0}^{k - 1} {α}_{ij}^{( 1 )} \sqrt{2} {ϕ}_{j} ( 2 x - 1 ) . \qquad ( 27 )$$

It is straightforward to see that if ϕᵢ and ϕᵢₗ¹ are defined w.r.t. same measure, or μ₀=μ₁ almost everywhere (a.e.), then the filters transforming the multiwavelet coefficients from higher to lower scale, are exactly equal to the subspace mapping coefficients aᵢⱼ^{(0), a}ᵢⱼ⁽¹⁾ (by taking inner-product with f on both sides in (27)). However, this is not the case in-general, e.g., the measures w.r.t. which the basis are defined at each scale are not necessarily same. To remedy this issue, and to generalize the multiwavelet filters, we now present a general measure-variant version of the multiwavelet filters.

We note that, solving for filters H that satisfy eq. (26) indeed solves the general case of n +1->n scale, which can be obtained by a simple change of variables as s_{l,i}ⁿ=Σⱼ₌₀^{k-1}Hᵢⱼ⁽⁰⁾s_{2l,j}ⁿ⁺¹+Σⱼ₌₀^{k-1}Hᵢⱼ⁽¹⁾s_{2l+1,j}ⁿ⁺¹. Now, for solving (26), we consider the following equation

$${ϕ}_{i} ( x ) \frac{d {μ}_{0}}{d λ} ( x ) = {\sum }_{j = 0}^{k - 1} {H}_{ij}^{( 0 )} \sqrt{2} {ϕ}_{j} ( 2 x ) \frac{d {μ}_{1}}{d λ} ( x ) + {\sum }_{j = 0}^{k - 1} {H}_{ij}^{( 1 )} \sqrt{2} {ϕ}_{j} ( 2 x - 1 ) \frac{d {μ}_{1}}{d λ} ( x ) , \qquad ( 28 )$$

where

$$\frac{d μ}{d λ}$$

is the Radon-Nikodym derivative as discussed herein, and we have also defined dλ:=dx. We observe that eq. (26) can be obtained from (28) by simply integrating with ƒ on both sides.

Next, we observe an important fact about multiwavelets (or wavelets in-general) that the advantages offered by multiwavelets rely on their ability to project a function locally. One way to achieve this is by computing basis functions which are dilation/translations of a fixed mother wavelet, for example, FIG. 7. However, the idea can be generalized by projecting a given function onto any set of basis as long as they capture the locality. One approach to generalize is by using a tilt variant of the basis at higher scales, e.g., using \sqrt{2}\tilde{ϕ}ᵢ(2x)=\sqrt{2}ϕᵢ(2x)X₀(x), and \sqrt{2}\tilde{ϕ}ᵢ(2x−1)=\sqrt{2}ϕ₁(2x−1)X₁(x) such that \sqrt{2}\tilde{ϕ}ᵢ(2x) are now orthonormal w.r.t. weighting function w(2x)/X₀²(x), and similarly \sqrt{2}\tilde{ϕ}ᵢ(2x−1) w.r.t. w(2x−1)/X₁²(x). By choosing X₀(x)=w(2x)/w(x), and X₁(x)=w(2x−1)/w(x), and taking the new tilted measure \tilde{μ}₁ such that

$${\tilde{μ}}_{1} ( [ 0 , 1 ] ) = {\int }_{0}^{1 / 2} \frac{w ( 2 x )}{{χ}_{0}^{2} ( x )} d λ ( x ) + {\int }_{1 / 2}^{1} \frac{w ( 2 x - 1 )}{{χ}_{1}^{2} ( x )} d λ ( x ) , \\ or , \\ \frac{d {\tilde{μ}}_{1}}{d λ} ( x ) = \{ \begin{matrix}\frac{w ( 2 x )}{{χ}_{0}^{2} ( x )} & 0 \leq x \leq 1 / 2 , \\ \frac{w ( 2 x - 1 )}{{χ}_{1}^{2} ( x )} & 1 / 2 < c \leq 1\end{matrix} .$$

We re-write the eq. (28), by substituting ϕᵢ(2x)←\tilde{ϕ}ᵢ(2x), ϕᵢ(2x−1)←\tilde{ϕ}ᵢ(2x−1) and μ₁←\tilde{μ}₁, in its most useful form for the present techniques as follows

$${ϕ}_{i} ( x ) w ( x ) = {\sum }_{j = 0}^{k - 1} {H}_{ij}^{( 0 )} \sqrt{2} {ϕ}_{j} ( 2 x ) w ( x ) + {\sum }_{j = 0}^{k - 1} {H}_{ij}^{( 0 )} \sqrt{2} {ϕ}_{j} ( 2 x - 1 ) w ( x ) , \qquad ( 29 )$$

$$or ,$$

$${ϕ}_{i} ( x ) w ( x ) = {\sum }_{j = 0}^{k - 1} {H}_{ij}^{( 0 )} \sqrt{2} {ϕ}_{j} ( 2 x ) + {\sum }_{j = 0}^{k - 1} {H}_{ij}^{( 0 )} \sqrt{2} {ϕ}_{j} ( 2 x - 1 ) ,$$

Thus, filter coefficients can be looked upon as subspace projection coefficients, with a proper choice of tilted basis. Note that eq. (33) is now equivalent to (27) but is an outcome of a different back-end machinery. Since, \sqrt{2}ϕⱼ(2x), \sqrt{2}ϕⱼ(2x−1) are orthonormal basis for V₁^{k}, we have

$$2 {\int }_{0}^{1 / 2} {ϕ}_{i} ( 2 x ) {ϕ}_{j} ( 2 x ) w ( 2 x ) dx = {δ}_{ij} ,$$

$$2 {\int }_{1 / 2}^{1} {ϕ}_{i} ( 2 x - 1 ) {ϕ}_{j} ( 2 x - 1 ) w ( 2 x - 1 ) dx = {δ}_{ij} ,$$

and hence we obtain the filter coefficients as follows

$${H}_{ij}^{( 0 )} = \sqrt{2} {\int }_{0}^{1 / 2} {ϕ}_{i} ( 2 x ) {ϕ}_{j} ( 2 x ) w ( 2 x ) dx , \qquad ( 30 )$$

$${H}_{ij}^{( 1 )} = \sqrt{2} {\int }_{1 / 2}^{1} {ϕ}_{i} ( x ) {ϕ}_{j} ( 2 x - 1 ) w ( 2 x - 1 ) dx . \qquad ( 31 )$$

For a given set of basis of V₀^{k} as ϕ₀, . . . , ϕₖ₋₁ defined w.r.t. measure/weight function w(x), the filter coefficients H can be derived by solving eq. (29). In a similar way, if ψ₀, . . . , ψₖ₋₁ is the basis for the multiwavelet subspace W₀^{k} w.r.t. measure μ₀ such that V₀^{k}⊕W₀^{k}=V₁^{k}, and the projection of function ƒ over W₀^{k} is denoted by d_{0,i}⁰= [symbol] ƒ, ψᵢ [symbol] _{μ}_{₀}, then the filter coefficients for obtaining the multiwavelet coefficients is written as

$${d}_{0 i}^{0} = {\sum }_{l = 0 , 1} {\sum }_{j = 0}^{k - 1} {G}_{ij}^{( l )} {s}_{lj}^{1} . \qquad ( 32 )$$

Again using a change of variables, we get d_{l,i}ⁿ=Σⱼ₌₀^{k-1}Gᵢⱼ⁽⁰⁾s_{2l,j}ⁿ⁺¹+Σⱼ₌₀^{k-1}Gᵢⱼ⁽¹⁾s_{2l+1,j}ⁿ⁺¹. To solve for G in (32), similar to eq. (29), the measure-variant multiwavelet basis transformation (with appropriate tilt) is written as

$${φ}_{i} ( x ) {\sum }_{j = 0}^{k - 1} {G}_{ij}^{( 0 )} \sqrt{2} {ϕ}_{j} ( 2 x ) {\sum }_{j = 0}^{k - 1} {G}_{ij}^{( 0 )} \sqrt{2} {ϕ}_{j} ( 2 x - 1 ) , ( a . e . ) \qquad ( 33 )$$

Similar to eq. (30)-(31), the filter coefficients G can be obtained from (33) as follows

$${G}_{ij}^{( 0 )} = \sqrt{2} {\int }_{0}^{1 / 2} {φ}_{i} ( x ) {ϕ}_{j} ( 2 x ) w ( 2 x ) dx , \qquad ( 34 )$$

$${G}_{ij}^{( 1 )} = \sqrt{2} {\int }_{1 / 2}^{1} {φ}_{i} ( x ) {ϕ}_{j} ( 2 x - 1 ) w ( 2 x - 1 ) dx . \qquad ( 35 )$$

Since [symbol] ϕᵢ, ϕ_{ƒ} [symbol] _{μ}_{₀}=δᵢⱼ, [symbol] ψᵢ, ψⱼ [symbol] _{μ}_{₀} and [symbol] ϕᵢ, ϕⱼ [symbol] _{_82} _{₀}=0 therefore, using (29), (33), we can write that

$${\int }_{0}^{1} {ϕ}_{i} ( x ) {ϕ}_{j} ( x ) w ( x ) dx = 2 {\sum }_{l = 0}^{k - 1} {\sum }_{{l}^{′} = 0}^{k - 1} {H}_{il}^{( 0 )} {H}_{{jl}^{′}}^{( 0 )} {\int }_{0}^{1 / 2} {ϕ}_{l} ( 2 x ) {ϕ}_{{l}^{′}} ( 2 x ) w ( 2 x ) dx + 2 {\sum }_{l = 0}^{k - 1} {\sum }_{{l}^{′} = 0}^{k - 1} {H}_{il}^{( 1 )} {H}_{{jl}^{′}}^{( 1 )} {\int }_{1 / 2}^{1} {ϕ}_{l} ( 2 x - 1 ) {ϕ}_{{l}^{′}} ( 2 x - 1 ) w ( x ) dx \qquad ( 36 )$$

$${\int }_{0}^{1} {ψ}_{i} ( x ) {ψ}_{j} ( x ) w ( x ) dx = 2 {\sum }_{l = 0}^{k - 1} {\sum }_{{l}^{′} = 0}^{k - 1} {G}_{il}^{( 0 )} {G}_{{jl}^{′}}^{( 0 )} {\int }_{0}^{1 / 2} {ϕ}_{l} ( 2 x ) {ϕ}_{{l}^{′}} ( 2 x ) w ( x ) dx + 2 {\sum }_{l = 0}^{k - 1} {\sum }_{{l}^{′} = 0}^{k - 1} {G}_{il}^{( 1 )} {G}_{{jl}^{′}}^{( 1 )} {\int }_{1 / 2}^{1} {ϕ}_{l} ( 2 x - 1 ) {ϕ}_{{l}^{′}} ( 2 x - 1 ) w ( x ) dx \qquad ( 37 )$$

$$0 = 2 {\sum }_{l = 0}^{k - 1} {\sum }_{{l}^{′} = 0}^{k - 1} {H}_{il}^{( 0 )} {G}_{{jl}^{′}}^{( 0 )} {\int }_{0}^{1 / 2} {ϕ}_{l} ( 2 x ) {ϕ}_{{l}^{′}} ( 2 x ) w ( x ) dx + 2 {\sum }_{l = 0}^{k - 1} {\sum }_{{l}^{′} = 0}^{k - 1} {H}_{il}^{( 1 )} {G}_{{jl}^{′}}^{( 1 )} {\int }_{1 / 2}^{1} {ϕ}_{l} ( 2 x - 1 ) {ϕ}_{{l}^{′}} ( 2 x - 1 ) w ( x ) dx . \qquad ( 38 )$$

Let us define filter matrices as H^{(l)}=[Hᵢⱼ^{(l)}]∈ [symbol] ^{k×k} and G^{(l)=[G}ᵢⱼ^{(l)}]∈ [symbol] ^{k×k} for l=0,1. Also, we define correction matrices as Σ⁽⁰⁾=[Σᵢⱼ ⁽⁰⁾], Σ⁽¹⁾=[Σᵢⱼ⁽¹⁾] such that

$${\sum }_{ij}^{( 0 )} = 2 {\int }_{0}^{1 / 2} {ϕ}_{i} ( 2 x ) {ϕ}_{j} ( 2 x ) w ( x ) dx , \qquad ( 39 )$$

$${\sum }_{ij}^{( 0 )} = 2 {\int }_{1 / 2}^{1} {ϕ}_{i} ( 2 x - 1 ) {ϕ}_{j} ( 2 x - 1 ) w ( x ) dx .$$

Now, we can write that

$${H}^{( 0 )} {\sum }^{( 0 )} {H}^{( 0 ) T} + {H}^{( 1 )} {\sum }^{( 1 )} {H}^{( 1 ) T} = I , \qquad ( 40 )$$

$${G}^{( 0 )} {\sum }^{( 0 )} {G}^{( 0 ) T} + {G}^{( 1 )} {\sum }^{( 1 )} {G}^{( 1 ) T} = I ,$$

$${H}^{( 0 )} {\sum }^{( 0 )} {G}^{( 0 ) T} + {H}^{( 1 )} {\sum }^{( 1 )} {G}^{( 1 ) T} = 0.$$

Rearranging eq. we can finally express the relationships between filter matrices and correction matrices as follows

$${[ \begin{matrix}{H}^{( 0 )} & {H}^{( 1 )} \\ {G}^{( 0 )} & {G}^{( 1 )}\end{matrix} ] [ \begin{matrix}{\sum }^{( 0 )} & 0 \\ 0 & {\sum }^{( 0 )}\end{matrix} ] [ \begin{matrix}{H}^{( 0 )} & {H}^{( 1 )} \\ {G}^{( 0 )} & {G}^{( 1 )}\end{matrix} ]}^{T} = I . \qquad ( 41 )$$

The discussion till now is related to ‘decomposition’ or transformation of multiwavelet transform coefficients from higher to lower scale. However, the other direction, e.g., ‘reconstruction’ or transformation from lower to higher scale can also be obtained from (41). First, note that the general form of eq. (26), (32) can be written in the matrix format as

$${s}_{l}^{n} = {H}^{( 0 )} {s}_{2 l}^{n + 1} + {H}^{( 1 )} {s}_{2 l + 1}^{n + 1} , \qquad ( 42 )$$

$${d}_{l}^{n} = {G}^{( 0 )} {s}_{2 l}^{n + 1} + {G}^{( 1 )} {s}_{2 l + 1}^{n + 1} .$$

Next, we observe that Σ⁽⁰⁾, Σ⁽¹⁾ [symbol] 0, which follows from their definition. Therefore, eq. (41) can be inverted to get the following form

$${[ \begin{matrix}{H}^{( 0 )} & {H}^{( 1 )} \\ {G}^{( 0 )} & {G}^{( 1 )}\end{matrix} ] [ \begin{matrix}{H}^{( 0 )} & {H}^{( 1 )} \\ {G}^{( 0 )} & {G}^{( 1 )}\end{matrix} ]}^{T} = [ \begin{matrix}{\sum }^{( 0 ) - 1} & 0 \\ 0 & {\sum }^{( 1 ) - 1}\end{matrix} ] . \qquad ( 43 )$$

Finally, by using (43), we can essentially invert the eq. (42) to get

$${s}_{2 l}^{n + 1} = {\sum }^{( 0 )} ( {H}^{( 0 ) T} {s}_{l}^{n} + {G}^{( 0 ) T} {d}_{l}^{n} ) , \qquad ( 44 )$$

$${s}_{2 l + 1}^{n + 1} = {\sum }^{( 1 )} ( {H}^{( 1 ) T} {s}_{l}^{n} + {G}^{( 1 ) T} {d}_{l}^{n} ) .$$

In the following section, we see the filters H, G in (42), (44) for different polynomial basis.

### Multiwavelets Using Legendre Polynomials

The basis for Vo are chosen as normalized shifted Legendre polynomials of degree upto k w.r.t. weight function w_{L}(2x−1)=1_{[0,1]}(x), previously discussed. For example, the first three bases are

$${ϕ}_{0} ( x ) = 1 \qquad ( 45 )$$

$${ϕ}_{1} ( x ) = \sqrt{3} ( 2 x - 1 )$$

$${ϕ}_{2} ( x ) = \sqrt{5} ( 6 {x}^{2} - 6 x + 1 ) , 0 \leq x \leq 1$$

For deriving a set of basis ψᵢ of W₀^{k} using GSO, we can evaluate the integrals which could be done efficiently using Gaussian quadrature.

Gaussian-Legendre Quadrature: The integrals involved in GSO procedure, and the computations of H, G can be done efficiently using the Gaussian quadrature as discussed previously. Since the basis functions ϕᵢ, ψᵢ are polynomials, therefore, the quadrature summation would be exact. For a given k basis of the subspace V₀^{k}, the deg (ϕᵢϕⱼ)<2k−1, as well as deg (ϕᵢψⱼ)<2k−1, therefore a k-point quadrature can be used for expressing the integrals. Next, we take the interval [a, b] = [0,1], and the OPs for approximation in Gaussian quadrature as shifted Legendre polynomials Pₖ(2x−1). The weight coefficients ωᵢ can be written as

$${ω}_{i} = \frac{{a}_{k}}{{a}_{k - 1}} \frac{{\int }_{0}^{1} {P}_{k - 1}^{2} ( 2 x - 1 ) w ( 2 x - 1 ) dx}{{P}_{k}^{′} ( 2 {x}_{i} - 1 ) {P}_{k - 1} ( 2 {x}_{i} - 1 )} = \frac{2 k - 1}{k} \cdot \frac{1}{2 k - 1} \frac{1}{{P}_{k}^{′} ( 2 {x}_{i} - 1 ) {P}_{k - 1} ( 2 {x}_{i} - 1 )} = \frac{1}{{kP}_{k}^{′} ( 2 {x}_{i} - 1 ) {P}_{k - 1} ( 2 {x}_{i} - 1 )} , \qquad ( 46 )$$

where xᵢ are the k roots of Pₖ(2x−1) and aₖ can be expressed in terms of aₖ−1 using the recurrence relationship of Legendre polynomials from Section A.2.1.

A set of basis for V₁^{k} is \sqrt{2}ϕᵢ(2x) and \sqrt{2}ϕᵢ(2x−1) with weight functions w_{L}(4x−1)=1_{[0,1/2]}(x) and w_{L}(4x−3)=1_{[1/2,1]}(x), respectively. We now use GSO procedure, as discussed previously, to obtain set of basis ψ₀, . . . , ψₖ₋₁ for W₀^{k}. We use Gaussian-Legendre quadrature formulas for computing the inner-products. As an example, the inner-products are computed as follows

$$\begin{matrix}{〈 \sqrt{2} {ϕ}_{i} , {ϕ}_{j} 〉}_{{μ}_{0}} = {\int }_{0}^{1} \sqrt{2} {ϕ}_{i} ( 2 x ) {ϕ}_{j} ( x ) {w}_{L} ( 2 x - 1 ) dx \\ = \sqrt{2} {\sum }_{i = 1}^{k} {ω}_{i} {ϕ}_{i} ( 2 x ) {ϕ}_{j} ( {x}_{i} ) ,\end{matrix}$$

where ϕᵢ(2xᵢ)=0 for xᵢ>0.5.

With shifted Legendre polynomials as basis for V₀³, the multiwavelet bases for W₀³ are

$${ψ}_{0} ( x ) = \{ \begin{matrix}\begin{matrix}6 x - 1 & 0 \leq x \leq 1 / 2 ,\end{matrix} \\ \begin{matrix}6 x - 5 & 1 / 2 < x \leq 1 ,\end{matrix}\end{matrix} \qquad ( 47 )$$

$${ψ}_{1} ( x ) = \{ \begin{matrix}\begin{matrix}\sqrt{3} ( 30 {x}^{2} - 14 x + 1 ) & 0 \leq x \leq 1 / 2 ,\end{matrix} \\ \begin{matrix}\sqrt{3} ( 30 {x}^{2} - 46 x + 17 ) & 1 / 2 < x \leq 1 ,\end{matrix}\end{matrix}$$

$${ψ}_{2} ( x ) = \{ \begin{matrix}\begin{matrix}\sqrt{5} ( 24 {x}^{2} - 12 x + 1 ) & 0 \leq x \leq 1 / 2 ,\end{matrix} \\ \begin{matrix}\sqrt{5} ( - 24 {x}^{2} + 36 x - 13 ) & 1 / 2 < x \leq 1.\end{matrix}\end{matrix}$$

Next, we compute the filter matrices, but first note that since the weighting function for Legendre polynomials basis are w_{L}(x)=1_{[0,1]}(x), therefore, Σ⁽⁰⁾, Σ⁽¹⁾ in eq. (39) are just identity matrices because of orthonormality of the basis \sqrt{2}ϕᵢ(2x) and \sqrt{2}ϕᵢ(2x)−1 w.r.t. 1_{[0,1/2}]^{(x)} and 1_{[1/2,1]}(x), respectively. The filter coefficients can be computed using Gaussian-Legendre quadrature as follows

$$\begin{matrix}{H}_{ij}^{( 0 )} = \sqrt{2} {\int }_{0}^{1 / 2} {ϕ}_{i} ( x ) {ϕ}_{j} ( 2 x ) {w}_{Ch} ( 4 x - 1 ) dx \\ = \frac{1}{\sqrt{2}} {\int }_{0}^{1} {ϕ}_{i} ( x / 2 ) {ϕ}_{j} ( x ) {w}_{Ch} ( 2 x - 1 ) dx \\ = \frac{π}{2 \sqrt{2}} {\sum }_{i = 1}^{k} {ϕ}_{i} ( \frac{{x}_{i}}{2} ) {ϕ}_{j} ( {x}_{i} ) ,\end{matrix}$$

and similarly other coefficients can be obtained in eq. (30)-(31), (34)-(35). As an example, for k=3, following the outlined procedure, the filter coefficients are derived as follows

$${H}^{( 0 )} = [ \begin{matrix}\frac{1}{\sqrt{2}} & 0 & 0 \\ - \frac{\sqrt{3}}{2 \sqrt{2}} & \frac{1}{2 \sqrt{2}} & 0 \\ 0 & - \frac{\sqrt{15}}{4 \sqrt{2}} & \frac{1}{4 \sqrt{2}}\end{matrix} ] ,$$

$${H}^{( 1 )} = [ \begin{matrix}\frac{1}{\sqrt{2}} & 0 & 0 \\ \frac{\sqrt{3}}{2 \sqrt{2}} & \frac{1}{2 \sqrt{2}} & 0 \\ 0 & \frac{\sqrt{15}}{4 \sqrt{2}} & \frac{1}{4 \sqrt{2}}\end{matrix} ] ,$$

$${G}^{( 0 )} = [ \begin{matrix}\frac{1}{\sqrt{2}} & \frac{\sqrt{3}}{2 \sqrt{2}} & 0 \\ 0 & \frac{1}{4 \sqrt{2}} & \frac{\sqrt{15}}{4 \sqrt{2}} \\ 0 & 0 & \frac{1}{\sqrt{2}}\end{matrix} ] ,$$

$${G}^{( 1 )} = [ \begin{matrix}- \frac{1}{2 \sqrt{2}} & \frac{\sqrt{3}}{2 \sqrt{2}} & 0 \\ 0 & - \frac{1}{4 \sqrt{2}} & \frac{\sqrt{15}}{4 \sqrt{2}} \\ 0 & 0 & - \frac{1}{\sqrt{2}}\end{matrix} ] .$$

### Multiwavelets Using Chebyshev Polynomials

We choose the basis for V₀^{k} as shifted Chebyshev polynomials of the first-order from degree 0 to k−1. The weighting function for shifted Chebyshev polynomials is w_{Ch}(2x−1)=1\sqrt{1−(2x−1)²} as discussed herein.

The first three bases using Chebyshev polynomials are as follows

$$\begin{matrix}{ϕ}_{0 ( x ) = \sqrt{2 / π}} \\ {ϕ}_{1} ( x ) = \frac{2}{\sqrt{π}} ( 2 x - 1 ) , \\ {ϕ}_{2} ( x ) = \frac{2}{\sqrt{π}} ( 8 {x}^{2} - 8 x + 1 ) , 0 \leq x \leq 1\end{matrix}$$

The Gaussian quadrature for the Chebyshev polynomials is used to evaluate the integrals that appears in the GSO procedure as well as in the computations of filters H, G.

Gaussian-Chebyshev Quadrature: The basis functions ϕᵢ, ψᵢ resulting from the use of shifted Chebyshev polynomials are also polynomials with degree of their products such that deg (ϕᵢϕⱼ)<2k−1 and deg(ϕᵢψⱼ)<2k−1, therefore a k-point quadrature can be used for evaluating the integrals that have products of bases. Upon taking the interval [a, b] as [0,1], and using the canonical OPs as shifted Chebyshev polynomials, the weight coefficients are written as

$${ω}_{i} = \frac{{a}_{k}}{{a}_{k - 1}} \frac{{\int }_{0}^{1} {T}_{k - 1}^{2} ( 2 x - 1 ) {w}_{Ch} ( 2 x - 1 ) dx}{{T}_{k}^{′} ( 2 {x}_{i} - 1 ) {T}_{k - 1} ( 2 {x}_{i} - 1 )} {=}^{( a )} 2 \frac{π}{4} \frac{1}{{T}_{k}^{′} ( 2 {x}_{i} - 1 ) {T}_{k - 1} ( 2 {x}_{i} - 1 )} {=}^{( b )} \frac{π}{2 k} , \qquad ( 48 )$$

where xᵢ are the k roots of Tₖ(2x−1), (a) is using the fact that aₙ/aₙ₋₁=2 by using the recurrence relationship of Chebyshev polynomials, as discussed herein, and assumes k>1 for the squared integral. For (b), we first note that Tₖ(cos θ)=cos(kθ), hence, T′ₖ(cos θ)=n sin(nθ)/sin(θ). Since xᵢ are the roots of Tₖ(2x−1), therefore,

$$2 {x}_{i} - 1 = cos ( \frac{π}{n} ( i - 1 / 2 ) ) .$$

Substituting the xᵢ, we get T′ₖ(2xᵢ−1)Tₖ₋₁(2xᵢ−1)=k.

A set of basis for V₁^{k} is \sqrt{2}ϕᵢ(2x) and \sqrt{2}ϕᵢ(2x−1) with weight functions w_{Ch}(4x−1)=1/\sqrt{1−(4x−1)²} and w_{Cb}(4x−3)=1/\sqrt{1−(4x−3)²}, respectively. We now use GSO procedure as previously outlined to obtain set of basis ψ₀, . . . , ψₖ₋₁ for W₀^{k}. We use Gaussian-Chebyshev quadrature formulas for computing the inner-products. As an example, the inner-products are computed as follows

$$\begin{matrix}{〈 \sqrt{2} {ϕ}_{i} , {ϕ}_{j} 〉}_{{μ}_{0}} = \sqrt{2} {ϕ}_{i} ( 2 x ) {ϕ}_{j} ( x ) {w}_{Ch} ( 2 x - 1 ) dx \\ = \sqrt{2} \frac{π}{2 k} {\sum }_{i = 1}^{k} {ϕ}_{i} ( 2 {x}_{i} ) {ϕ}_{j} ( {x}_{i} ) ,\end{matrix}$$

where ϕᵢ(2xᵢ)=0 for xᵢ>0.5.

With shifted Chebyshev polynomials as basis for V₀³, the multiwavelet bases for W₀³ are derived as

$${ψ}_{0} ( x ) = \{ \begin{matrix}\begin{matrix}4.9749 x - 0.556 & 0 \leq x \leq 1 / 2 ,\end{matrix} \\ \begin{matrix}49749 x - 4.4189 & 1 / 2 < x \leq 1 ,\end{matrix}\end{matrix} \qquad ( 49 )$$

$${ψ}_{1} ( x ) = \{ \begin{matrix}\begin{matrix}58.3516 {x}^{2} - 22.6187 x + 0.9326 & 0 \leq x \leq 1 / 2 ,\end{matrix} \\ 58.3516 \begin{matrix}{x}^{2} - 94.0846 x + 36.6655 & 1 / 2 < x \leq 1 ,\end{matrix}\end{matrix}$$

$${ψ}_{2} ( x ) = \{ \begin{matrix}\begin{matrix}59.0457 {x}^{2} - 23.7328 x + 1.0941 & 0 \leq x \leq 1 / 2 ,\end{matrix} \\ - \begin{matrix}59.0457 {x}^{2} + 94.358 x - 36.407 & 1 / 2 < x \leq 1.\end{matrix}\end{matrix}$$

Next, we compute the filter and the correction matrices. The filter coefficients can be computed using Gaussian-Chebyshev quadrature as follows

$$\begin{matrix}{H}_{ij}^{( 0 )} = \sqrt{2} {\int }_{0}^{1 / 2} {ϕ}_{i} ( x ) {ϕ}_{j} ( 2 x ) {w}_{Ch} ( 4 x - 1 ) dx \\ = \frac{1}{\sqrt{2}} {\int }_{0}^{1} {ϕ}_{i} ( x / 2 ) {ϕ}_{j} ( x ) {w}_{Ch} ( 2 x - 1 ) dx \\ = \frac{π}{2 \sqrt{2}} {\sum }_{i = 1}^{k} {ϕ}_{i} ( \frac{{x}_{i}}{2} ) {ϕ}_{j} ( {x}_{i} ) ,\end{matrix}$$

and similarly, other coefficients can be obtained in eq. (30)-(31), (34)-(35). Using the outlined procedure for Chebyshev based OP basis, for k=3, the filter and the corrections matrices are derived as

$${H}^{( 0 )} = [ \begin{matrix}\frac{1}{\sqrt{2}} & 0 & 0 \\ - \frac{1}{2} & \frac{1}{2 \sqrt{2}} & 0 \\ - \frac{1}{4} & - \frac{1}{\sqrt{2}} & \frac{1}{4 \sqrt{2}}\end{matrix} ] ,$$

$${H}^{( 1 )} = [ \begin{matrix}\frac{1}{\sqrt{2}} & 0 & 0 \\ \frac{1}{2} & \frac{1}{2 \sqrt{2}} & 0 \\ - \frac{1}{4} & \frac{1}{\sqrt{2}} & \frac{1}{4 \sqrt{2}}\end{matrix} ] ,$$

$${G}^{( 0 )} = [ \begin{matrix}0.6094 & 0.7794 & 0 \\ 0.6632 & 1.0272 & 1.1427 \\ 0.6172 & 0.907 & 1.1562\end{matrix} ] ,$$

$${G}^{( 1 )} = [ \begin{matrix}- 0.6094 & 0.7794 & 0 \\ 0.6632 & - 1.0272 & 1.1427 \\ - 0.6172 & 0.907 & - 1.1562\end{matrix} ] ,$$

$${Σ}^{( 0 )} = [ \begin{matrix}1 & - 0.4071 & - 0.2144 \\ - 0.4071 & 0.8483 & - 0.4482 \\ - 0.2144 & - 0.4482 & 0.84\end{matrix} ] ,$$

$${Σ}^{( 1 )} = [ \begin{matrix}1 & 0.4071 & - 0.2144 \\ 0.4071 & 0.8483 & - 0.4482 \\ - 0.2144 & 0.4482 & 0.84\end{matrix} ] .$$

### Numerical Considerations

The numerical computations of the filter matrices are done using Gaussian quadrature as discussed herein for Legendre and Chebyshev polynomials, respectively. For odd k, a root of the canonical polynomial (either Legendre, Chebyshev) would be exactly 0.5. Since the multiwavelets bases ψᵢ for W₀^{k} are discontinuous at 0.5, the quadrature sum can lead to an unexpected result due to the finite-precision of the roots xi. One solution for this is to add a small number ∈, ∈>0 to xᵢ to avoid the singularity. Another solution, which we have used, is to perform a \tilde{k}-quadrature, where \tilde{k}=2k. Note that, any high value of quadrature sum would work as long as it is greater than k, and we choose an even value to avoid the root at the singularity (x=0.5).

To check the validity of the numerically computed filter coefficients from the Gaussian quadrature, we can use eq. (41). In a k-point quadrature, the summation involves up to k degree polynomials, and we found that for large values of k, for example, k>20, the filter matrices tend to diverge from the mathematical constraint of (41). Note that this is not due to the involved mathematics but the precision offered by floating-point values. For these examples, we found values of k in the range of [1,6] to be most useful.

### Additional Results

We present numerical evaluation of the proposed multiwavelets-based models on an additional dataset of Navier-Stokes below. Next, we present numerical results for prediction at finer resolutions with the use of lower-resolution trained models. Subsequently, we present additional results on the evaluation of multiwavelets on pseudo-differential equations.

### Navier-Stokes Equation

Navier-Stokes Equations describe the motion of viscous fluid substances, which can be used to model the ocean currents, the weather, and air flow. We experiment on the 2-d Navier-Stokes equation for a viscous, incompressible fluid in vorticity form on the unit torus, where it takes the following form:

$$\begin{matrix}\frac{\partial w ( x , t )}{\partial t} + u ( x , t ) \cdot ∇ w ( x , t ) - v Δ w ( x , t ) = f ( x ) & x ∈ {( 0 , 1 )}^{2} , t ∈ ( o , T ] \\ ∇ \cdot u ( x , t ) = 0 , & x ∈ {( 0 , 1 )}^{2} , t ∈ ( o , T ] \\ {w}_{0} ( x ) = w ( x , t = 0 ) , & x ∈ {( 0 , 1 )}^{2}\end{matrix} \qquad ( 50 )$$

TABLE 3
Navier-Stokes Equation validation at various viscosities
v. Top: Our methods. Bottom: Other neural operator
techniques and other deep learning models.

| | v = 1e−3 | v = 1e−4 | v = 1e−4 | v = 1e−5 |
|---|---|---|---|---|
| | T = 50 | T = 30 | T = 30 | T = 20 |
| Networks | N = 1000 | N = 1000 | N = 10000 | N = 1000 |
| MWT Leg | 0.00625 | 0.1518 | 0.0667 | 0.1541 |
| MWT Chb | 0.00720 | 0.1574 | 0.0720 | 0.1667 |
| FNO-3D | 0.0086 | 0.1918 | 0.0820 | 0.1893 |
| FNO-2D | 0.0128 | 0.1559 | 0.0973 | 0.1556 |
| U-Net | 0.0245 | 0.2051 | 0.1190 | 0.1982 |
| TF-Net | 0.0225 | 0.2253 | 0.1168 | 0.2268 |
| Res-Net | 0.0701 | 0.2871 | 0.2311 | 0.2753 |

We set the experiments to learn the operator mapping the vorticity w up to time 10 to w at a later time T>10. A task for the neural operator is to map the first T time units to last T−10 time units of vorticity w. To compare with the state-of-the-art model FNO and other configurations under the same conditions, we use the same Navier-Stokes' data and the results that have been published in. The initial condition is sampled as Gaussian random fields where

$${w}_{0} \sim 𝒩 ( 0 , {7}^{\frac{3}{2}} {( - Δ + {7}^{2} I )}^{- 2.5} )$$

with periodic boundary conditions. The forcing function ƒ(x)=0.1(sin(2π(x₁+x₂)+cos(2π(x₁+x₂). The experiments are conducted with (1) the viscosities v=1e−4, the final time T=50, the number of training pairs N=1000; (2)v=1e−4, T=30, N=1000; (3)v=1e−4, T=30, N=10000; (4)v=1e−5, T=20, N=1000. The data sets are generated on a 256×256 grid and are subsampled to 64×64.

We see in Table 3 that the proposed MWT Leg outperforms the existing Neural operators as well as other deep NN benchmarks. The MWT models have used a 2d multiwavelet transform with k=3 for the vorticity w, and 3d convolutions in the A, B, C NNs for estimating the time-correlated kernels. The MWT models (both Leg and Chb) are trained for 500 epochs for all the experiments except for N=10000, T=30, v=1e−4 case where the models are trained for 200 epochs. Note that similar to FNO-2D, a time-recurrent version of the MWT models could also be trained and most likely will improve the resulting L2 error for the less data setups like N=1000, v=1e−4 and N=1000, v=1e−5. However, these experiments consider the 3d convolutions (for A, B, C) version.

### Prediction at Higher Resolutions

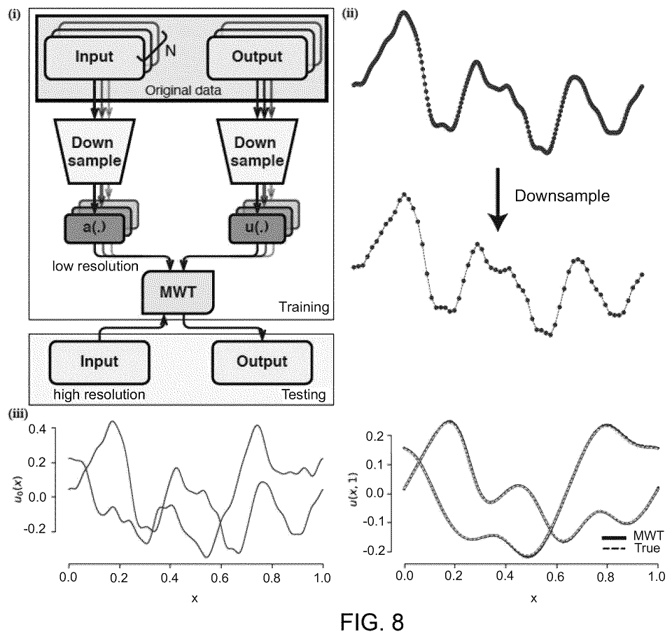

The proposed multiwavelets-based operator learning model is resolution-invariant by design. Upon learning an operator map between the function spaces, the proposed models have the ability to generalize beyond the training resolution. In this section, we evaluate the resolution extension property of the MWT models using the Burgers' equation dataset as described herein. A pipeline for the experiment is shown in FIG. 8. The numerical results for the experiments are shown in Table 4. We see that on training with a lower resolution, for example, s=256, the prediction error at 10× higher resolution s=2048 is 0.0226, or 2.26%. A sample input/output for learning at s=256 while predicting a s=8192 resolution is shown in FIG. 8. Also, learning at an even coarser resolution of s=128, the proposed model can predict the output of 26 times the resolution (e.g., s=8192) data with an relative L2 error of 4.56%.

TABLE 4
MWT Leg model trained at lower resolutions can
predict the output at higher resolutions.

| | Test | | |
|---|---|---|---|
| Train | s = 2048 | s = 4096 | s = 8192 |
| s = 128 | 0.0368 | 0.0389 | 0.0456 |
| s = 256 | 0.0226 | 0.0281 | 0.0321 |
| s = 512 | 0.0140 | 0.0191 | 0.0241 |

### Pseudo-Differential Equation

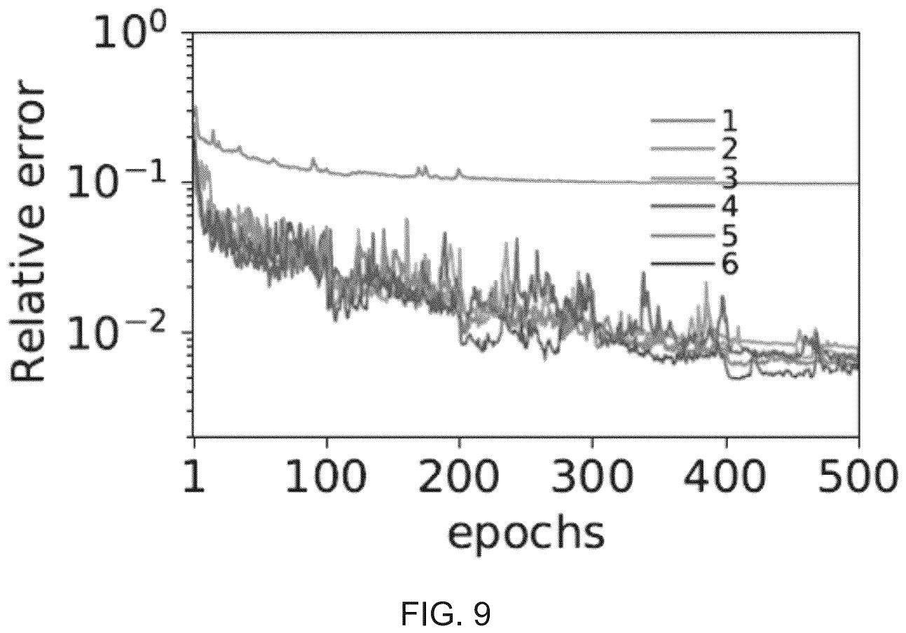

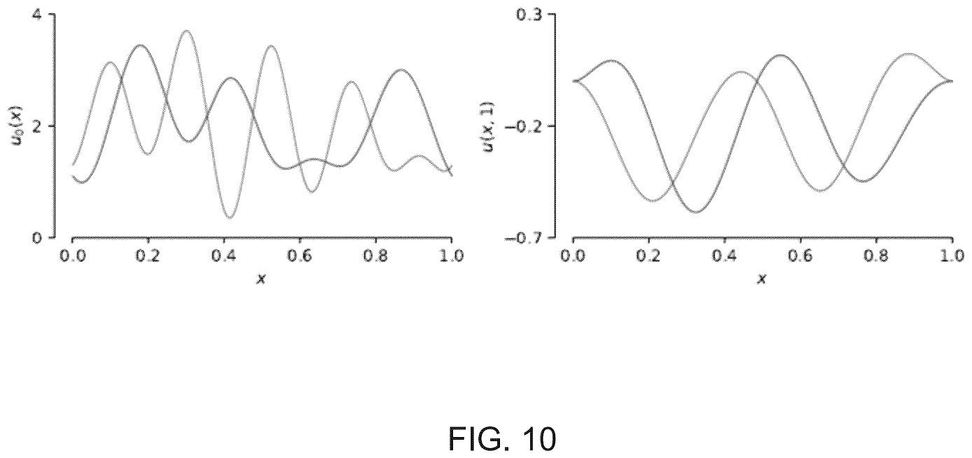

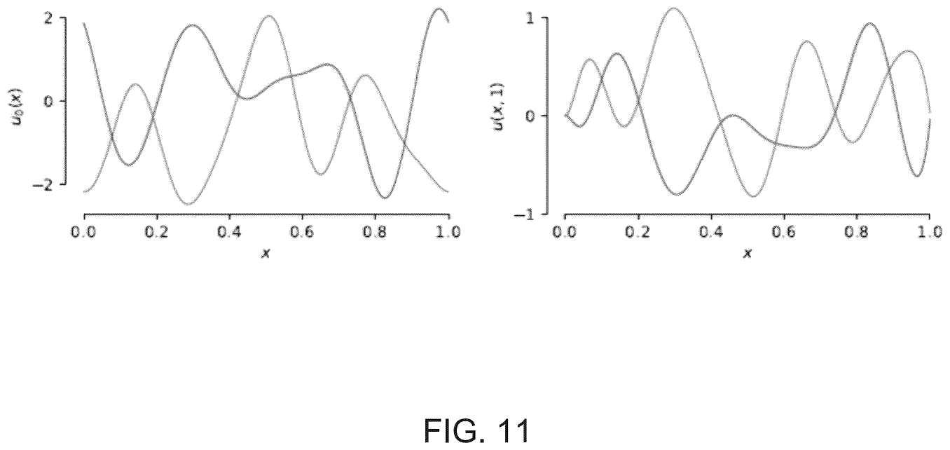

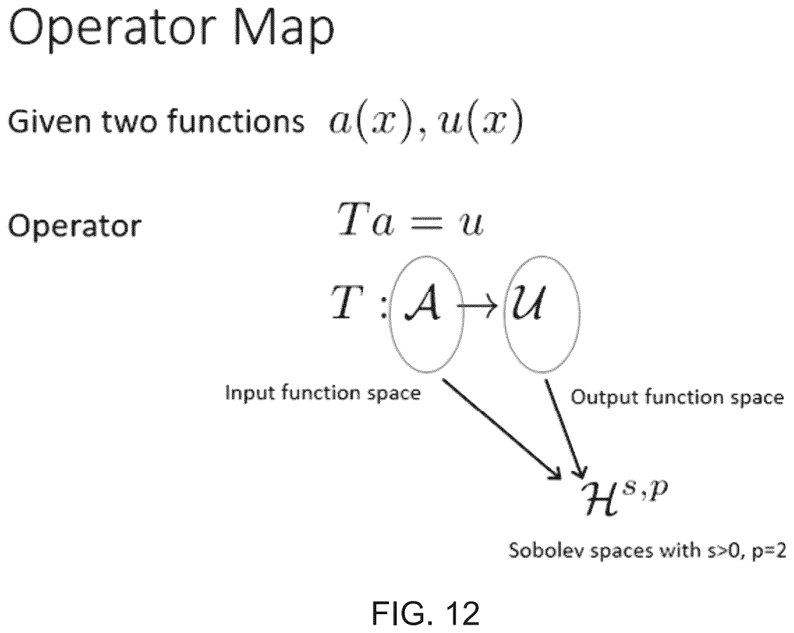

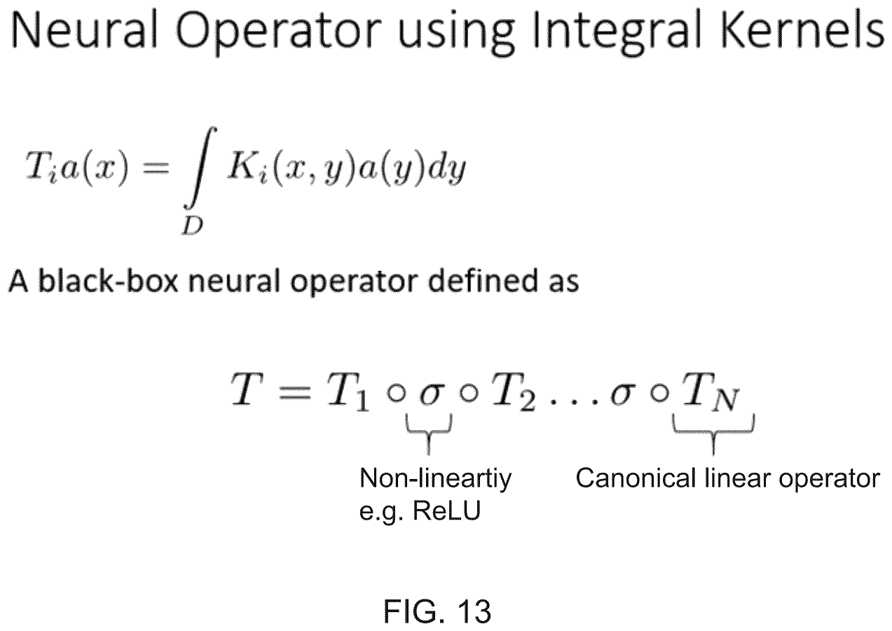

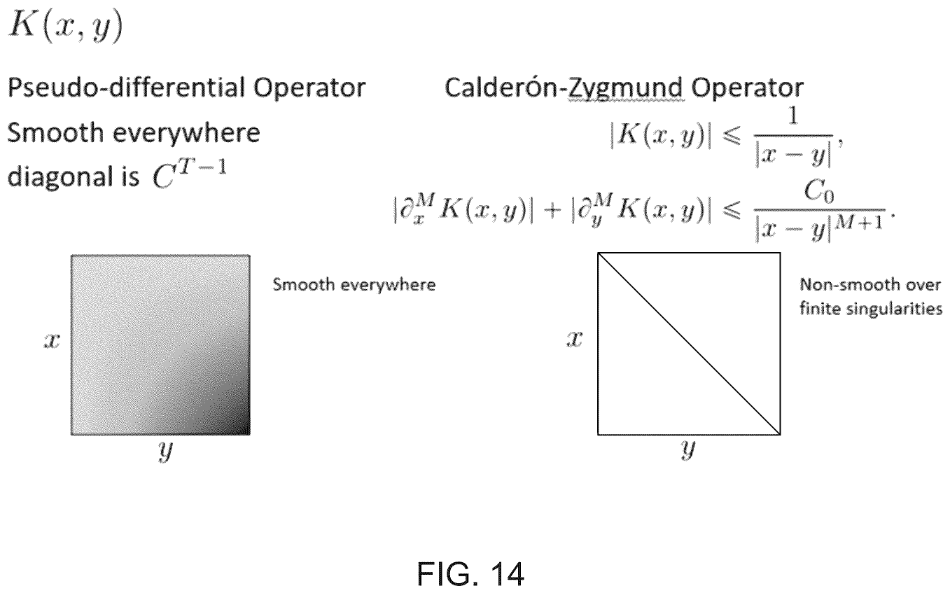

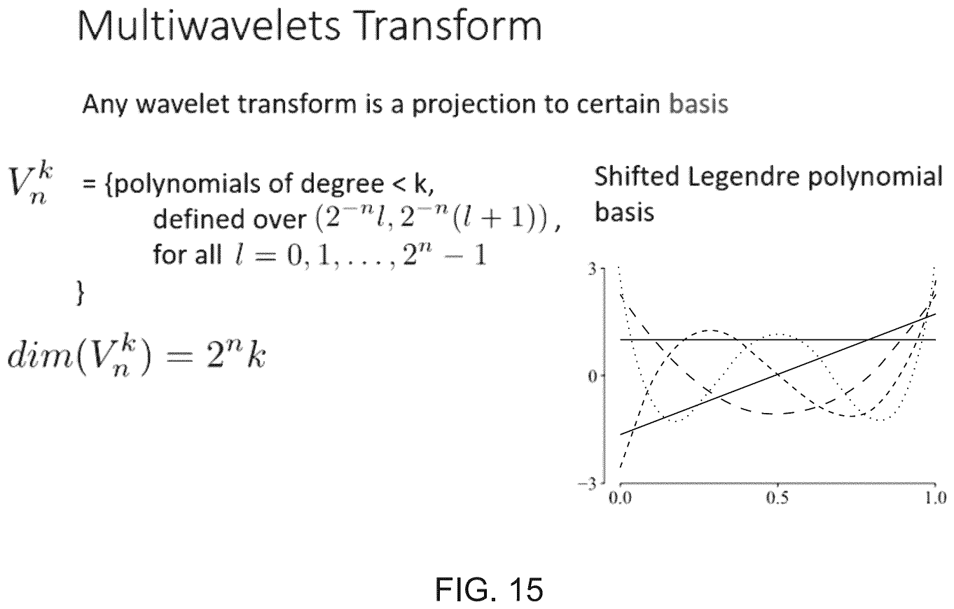

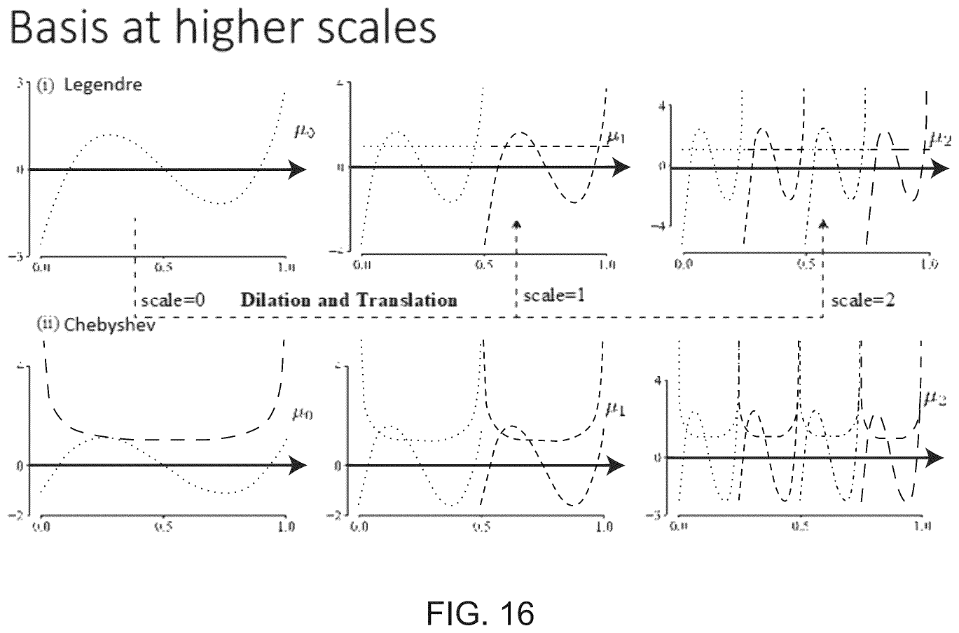

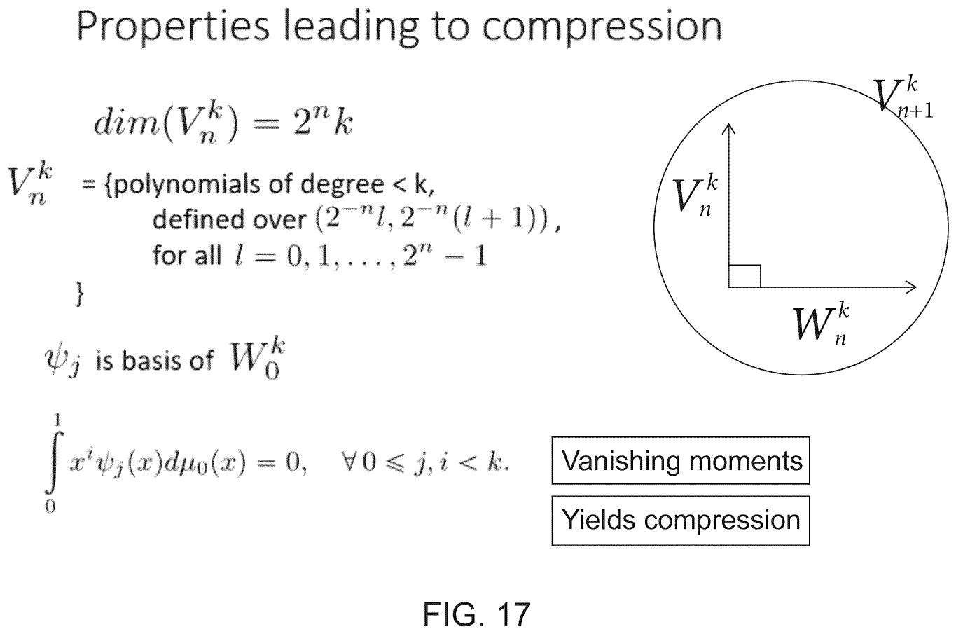

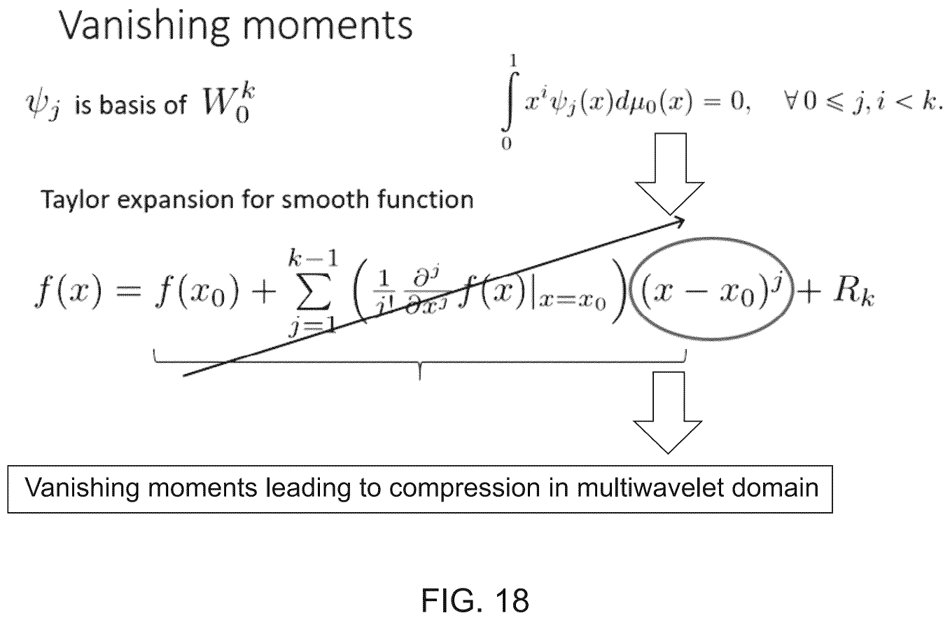

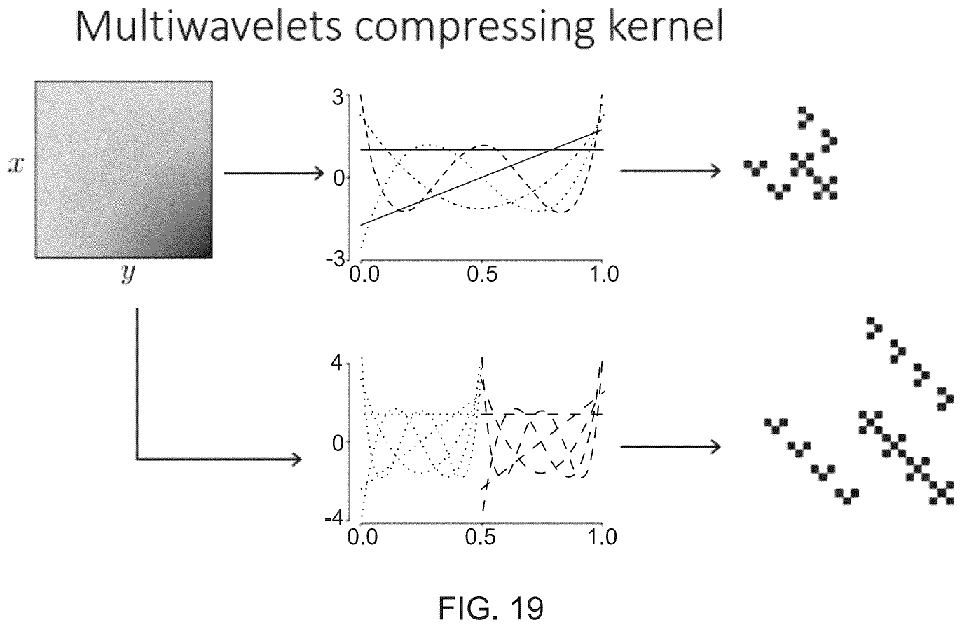

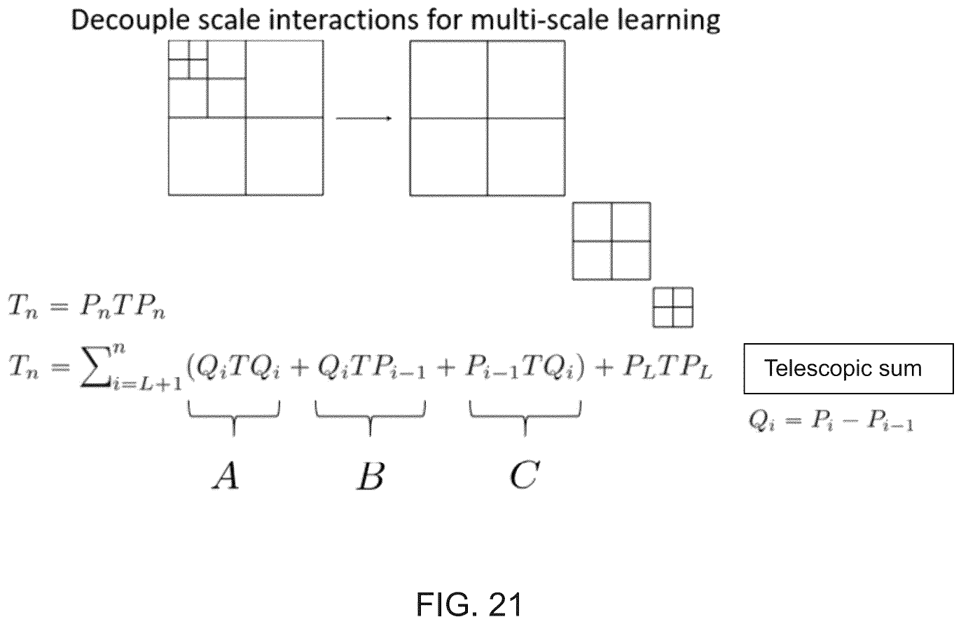

Similar to the experiments presented previously for the Euler-Bernoulli equation, we now present an additional result on a different pseudo-differential equation. We modify the Euler-Bernoulli beam to a 3rd order PDE as follows

$$\begin{matrix}\frac{{\partial }^{3} u}{\partial {u}^{3}} - {ω}^{2} u = f ( x ) , \frac{\partial u}{\partial x} {\vert}_{= 0} = 0 , & x ∈ [ 0 , 1 ] \\ u ( 0 ) = u ( 1 ) = 0 , & \end{matrix} \qquad ( 51 )$$

where u(x) is the Fourier transform of the time-varying displacement, ω=215 is the frequency, ƒ(x) is the external function. The eq. (51) is not known to have a physical meaning like Euler-Bernoulli, however, from a simulation point-of-view it can be used as a canonical PDE. A sample force function (input) and the solution of the PDE in (51) is shown in FIG. 11. The eq. (51) is a pseudo-differential equation with the maximum derivative order T+1=3. We now take the task of learning the map from ƒ to u. In FIG. 9, we see that for k≥2, the models relative error across epochs is similar, which again is in accordance with the Property 1, e.g., k>T−1 is can be used for annihilation the kernel away from the diagonal by multiwavelets. We saw a similar pattern for the 4th order PDE previously but for k≥3.

### Korteweg-de Vries (KdV) Equation

We present additional results for the Kdv equation different number of OP basis k. First, we demonstrate the operator learning when the input is sampled from a squared exponential kernel. Second, we experiment on the learning behavior of the Neural operators when the train and test samples are generated from different random sampling schemes.

TABLE 5
Korteweg-de Vries (KdV) equation benchmarks for different
input resolution s with input u₀(x) sampled from a squared
exponential kernel. Top: Our methods. Bottom: Other
neural operator techniques.

| Networks | s = 64 | s = 128 | s = 256 | s = 512 | s = 1024 |
|---|---|---|---|---|---|
| MWT Leg | 0.00190 | 0.00214 | 0.00204 | 0.00201 | 0.00211 |
| MWT Cheb | 0.00239 | 0.00241 | 0.00221 | 0.00289 | 0.00348 |
| FNO | 0.00335 | 0.00330 | 0.00375 | 0.00402 | 0.00456 |
| MGNO | 0.0761 | 0.0593 | 0.0724 | 0.0940 | 0.0660 |
| LNO | 0.0759 | 0.0756 | 0.0673 | 0.0807 | 0.0792 |
| GNO | 0.0871 | 0.0801 | 0.0722 | 0.0798 | 0.0777 |

### Squared Exponential Kernel

We sample the input u₀(x) from a squared exponential kernel, and solve the KdV equation in a similar setting as mentioned previously. Due to the periodic boundary conditions, a periodic version of the squared exponential kernel 160] is used as follows.

$$k ( x , {x}^{i} ) = exp ( - 2 \frac{{sin}^{2} ( π ( x - {x}^{′} ) / P )}{{L}^{2}} )$$

where, P is the domain length and Z is the smoothing parameter of the kernel. The random input function is sampled from [symbol] (0, Kₘ) with Kₘ being the kernel matrix by taking P=1 (domain length) and L=0.5 to avoid the sharp peaks in the sampled function. The results for the Neural operators (similar to Table 1) is shown in Table 5. We see that MWT models perform better than the existing neural operators at all resolutions.

### Training/Evaluation with Different Sampling Rules

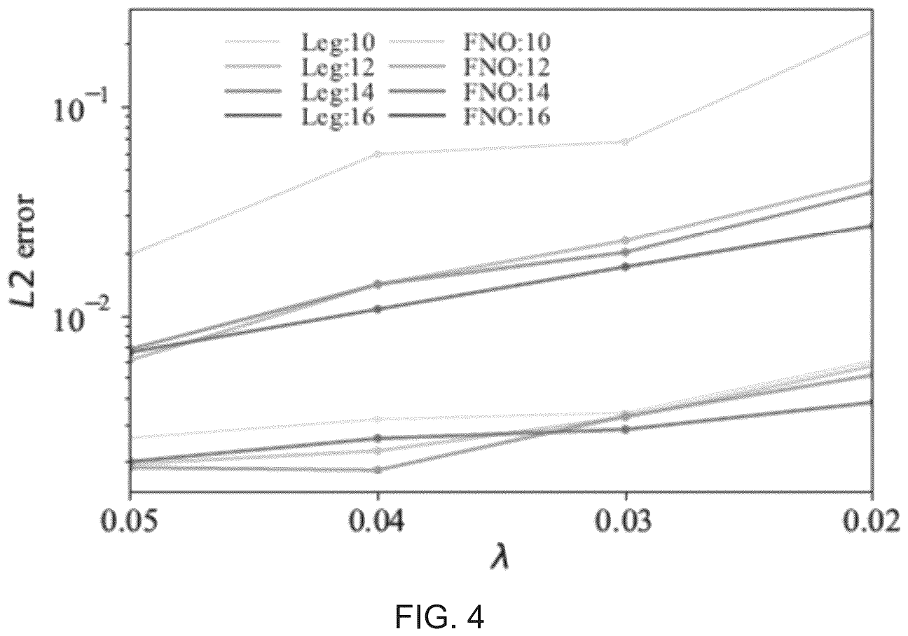

The experiments implementing the present techniques and also in other neural operator techniques have used the datasets such that the train and test samples are generated by sampling the input function using the same rule. For example, in KdV, a complete dataset is first generated by randomly sampling the inputs u₀(x) from [symbol] (0, 7⁴(Δ+7²I)^{-2.5}) and then splitting the dataset into train/test. This setting is useful when dealing with the systems such that the future evaluation function samples have similar patterns like smoothness, periodicity, presence of peaks. However, from the viewpoint of learning the operator between the function spaces, this is not a general setting. We have seen in FIG. 4 that upon varying the fluctuation strength in the inputs (both train and test), the performance of the neural operators differ. We now perform an addition experiment in which the neural operator is trained using the samples from a periodic squared exponential kernel and evaluated on the samples generated from random fields 132] with fluctuation parameter 2. We see in Table 6 that instead of different generating rules, the properties like fluctuation strength matters more when it comes to learning the operator map. Evaluation on samples that are generated from a different rule can still work well provided that the fluctuations are of similar nature. It is intuitive that by learning only from the low-frequency signals, the generalization to higher-frequency signals is difficult.

### Burgers Equation

The numerical values for the Burgers' equation experiment, as presented in FIG. 6, is provided in the Table 7.

TABLE 6
Neural operators performance when training on random inputs
sampled from Squared exponential kernel and testing on samples
generated from smooth random functions with controllable
parameter λ. The random functions are used as the input u₀(x)for
Korteweg-de Vries (KdV) equation as mentioned previously. In the
test data, λ is inversely proportional to sharpness of the fluctuations.

| | | | |
|---|---|---|---|
| Networks | λ = 0.25 | λ = 0.5 | λ = 0.75 |

s = 64

| | | | |
|---|---|---|---|
| MWT Leg | 0.00819 | 0.00413 | 0.00202 |
| MWT Cheb | 0.00751 | 0.00347 | 0.00210 |
| FNO | 0.0141 | 0.00822 | 0.00404 |
| MGNO | 0.3701 | 0.2030 | 0.0862 |
| LNO | 0.1012 | 0.0783 | 0.0141 |

s = 256

| | | | |
|---|---|---|---|
| MWT Leg | 0.00690 | 0.00322 | 0.00145 |
| MWT Cheb | 0.00616 | 0.00344 | 0.00182 |
| FNO | 0.0134 | 0.00901 | 0.00376 |
| MGNO | 0.4492 | 0.2114 | 0.1221 |
| LNO | 0.1306 | 0.0821 | 0.0161 |

s = 1024

| | | | |
|---|---|---|---|
| MWT Leg | 0.00641 | 0.00408 | 0.00127 |
| MWT Cheb | 0.00687 | 0.00333 | 0.00176 |
| FNO | 0.0141 | 0.00718 | 0.00359 |
| MGNO | 0.4774 | 0.2805 | 0.1309 |
| LNO | 0.1140 | 0.0752 | 0.0139 |

TABLE 7
Burgers' Equation validation at various input resolution s. Top: Our
methods. Bottom: Other neural operator techniques

| Networks | S = 256 | S = 512 | S = 1024 | S = 2048 | S = 4096 | S = 8192 |
|---|---|---|---|---|---|---|
| MWT Leg | 0.00199 | 0.00185 | 0.00184 | 0.00186 | 0.00185 | 0.00178 |
| MWT Chb | 0.00402 | 0.00381 | 0.00336 | 0.00395 | 0.00299 | 0.00289 |
| FNO | 0.00332 | 0.00333 | 0.00377 | 0.00346 | 0.00324 | 0.00336 |
| MGNO | 0.0243 | 0.0355 | 0.0374 | 0.0360 | 0.0364 | 0.0364 |
| LNO | 0.0212 | 0.0221 | 0.0217 | 0.0219 | 0.0200 | 0.0189 |
| GNO | 0.0555 | 0.0594 | 0.0651 | 0.0663 | 0.0666 | 0.0699 |

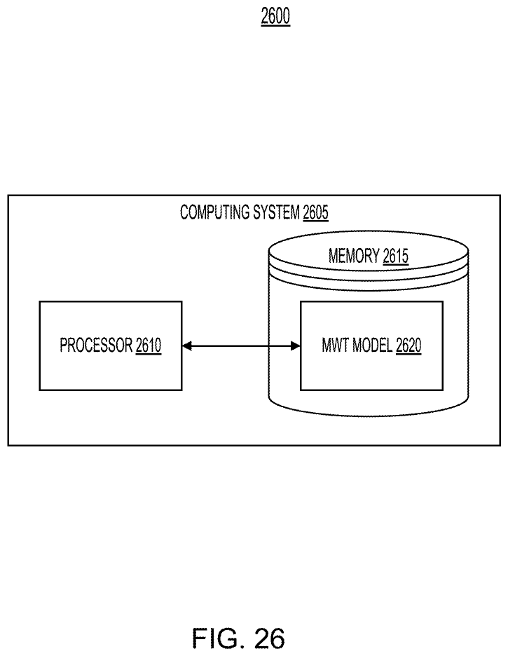

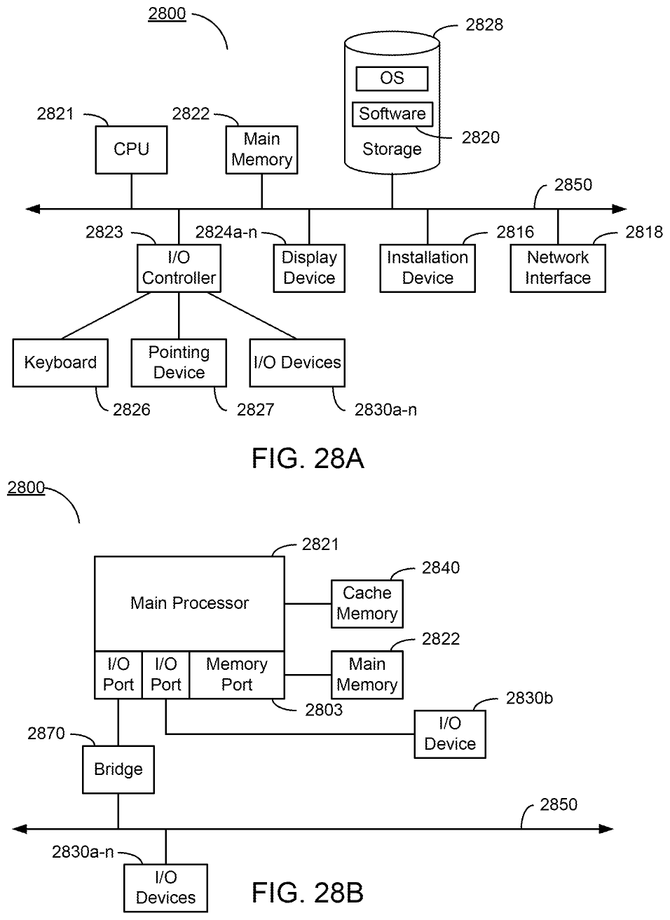

FIG. 26 illustrates an example system for multiwavelet-based operator learning for differential equations. The system 2600 can include a computing system 2605. The computing system 2605 can include a processor 2610, a memory 2615, and a MWT model 2620. The MWT model 2620 can be any of the implementations of the MWT model 2620 described herein. The processor 2610 may include a microprocessor, an application-specific integrated circuit (ASIC), a field-programmable gate array (FPGA), programmable logic circuits, or combinations thereof. The memory 2615 may include, but is not limited to, electronic, optical, magnetic, or any other storage or transmission device capable of providing the processor 2610 with program instructions. The memory 2615 may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The computing system 2605 can include one or more computing devices or components. The computing system 2605 can include any or all of the components and perform any or all of the functions of the computer system 2800 described in connection with FIGS. 28A and 28B. The computing system 2605 may communicate any input data or computational results of the techniques described herein with other components or computing devices using one or more communications interfaces (not pictured). Such communications interfaces can be or include any type of wired or wireless communication system, including suitable computer or logical interfaces or busses, for conducting data communications.

For example, the computing system 2605 may communicate with one or more interfaces, such as display interfaces, to present the results of any computations or calculations, or to provide insight into the differential equations learned using the MWT model 2620, as described herein. The MWT model 2620 can be any of the MWT implementations as described herein. The processor 2610 can execute processor-executable instructions to carry out the functionalities as described herein. The MWT model 2620 can be used to learn differential equations for a variety of applications. The MWT model 2620 can be, for example, the MWT model described herein in connection with FIG. 2. The MWT model 2620 can be used to learn differential equations for a perceptual model of a normal system, which can, for example, determine whether a trajectory of a robot or other device will violate a safety constraint (e.g., a boundary, a speed or acceleration limit, etc.). The MWT model 2620 may also be used for other applications, such as material science (e.g., molecular data simulations by determining an appropriate PDE, and use that PDE to optimize for particular requirements like elasticity, strength, etc.), or aerospace, among others. For example, PDEs can be learned to determine whether a particular wing design will be able to sustain a particular force. The MWT model 2620 can be used, using the techniques described herein, to learn turbulence equations (e.g., the Navier-Stokes equations) and they pressure they exert on a particular surface. The MWT model 2620 can determine the PDE for the Navier-Stokes equations at hypersonic speeds, and then analyze it to determine if the wing is strong enough. The MWT model 2620 may also be used for modeling the various infection rates and distributions of disease in populations, among any other type of PDE, as described herein.

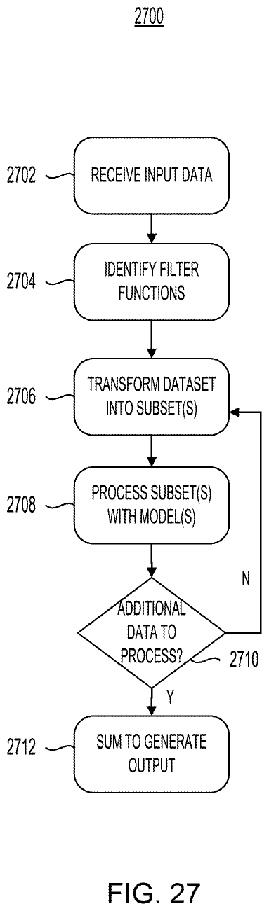

FIG. 27 depicts a flow chart of an example method 2700 of performing multiwavelet-based operator learning for differential equations, in accordance with one or more implementations. The method 2700 can be performed, for example, by the computing system 2605 described in connection with FIG. 26, or by the computer system 2800 described in connection with FIGS. 28A and 28B. The method 2700 can include receiving input data (STEP 2702), identifying filter functions (STEP 2704), transforming the dataset into subset(s) (STEP 2706), processing the subset(s) with one or more model(s) (STEP 2708), determining whether there is additional data to process (STEP 2710), and summing to generate an output (STEP 2712).

At step 2702, the method can include receiving input data. The input data may be sparse, and can depend on the particular application for which differential equations are being learned. The input data may be sorted data (e.g., in a particular sequence, such as an ordered time-series sequence of data, etc.). The input data may be received via a computer network, or may be provided via one or more communications interfaces or from a suitable storage medium.

At step 2704, the method can include identifying filter functions. The filter functions can be any type of the multiwavelet filter functions described herein (e.g., the filter functions H and G). In some implementations, the filter functions may be selected or identified based on the type of differential equations being learned (e.g., a predetermined or preselected set of filters, etc.). The filters can be any type of function that can take items of the data as input. The filter functions may be used in further steps of the method 2700.

At step 2706, the method can include' transforming the dataset into subset(s). To transform the data into subsets, the filters can be applied (e.g., executed over) the input data (or one or more of the subsets of data generated during an iteration of the method 2700). When executing the filter functions over the data, the data may be split may be split into one or more subsets (e.g., by bisecting the set of data into two equal subsets, etc.).

At step 2708, the method can include processing the subset(s) with one or more model(s). The models can be any type of neural network model, such as a deep neural network, a convolutional neural network, a recurrent neural network, or a fully connected neural network, among others. The models can be, for example, the NNs A, B and C, and T, as described herein. Processing the data can input providing one or more of the transformed subsets as input to one or more of the models to generate sets of output data. The output data for each iteration can be stored and ultimately combined in STEP 2712 to produce final output data. Each of the models may have the same hyperparameters or may have different hyperparameters. The models may be selected or trained for various applications, as described herein.

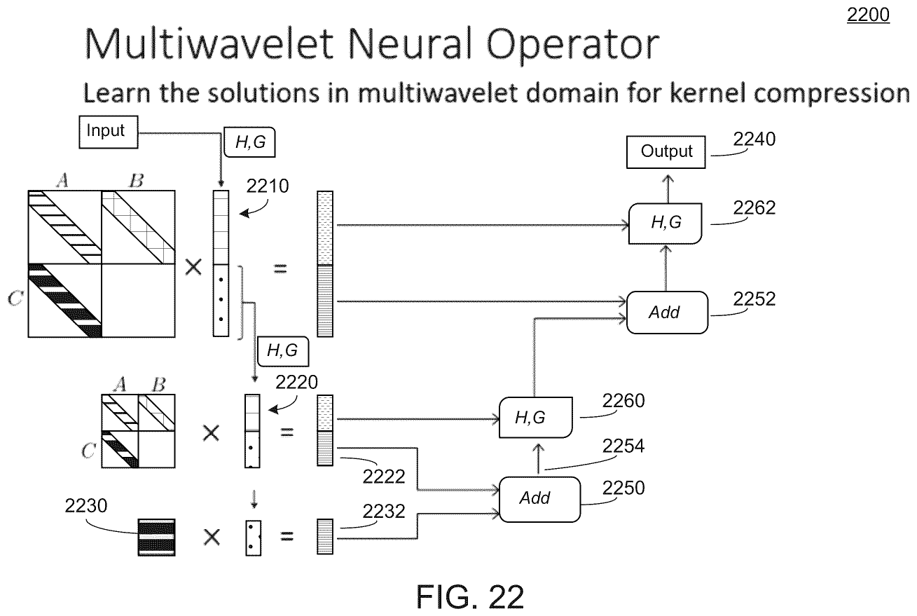

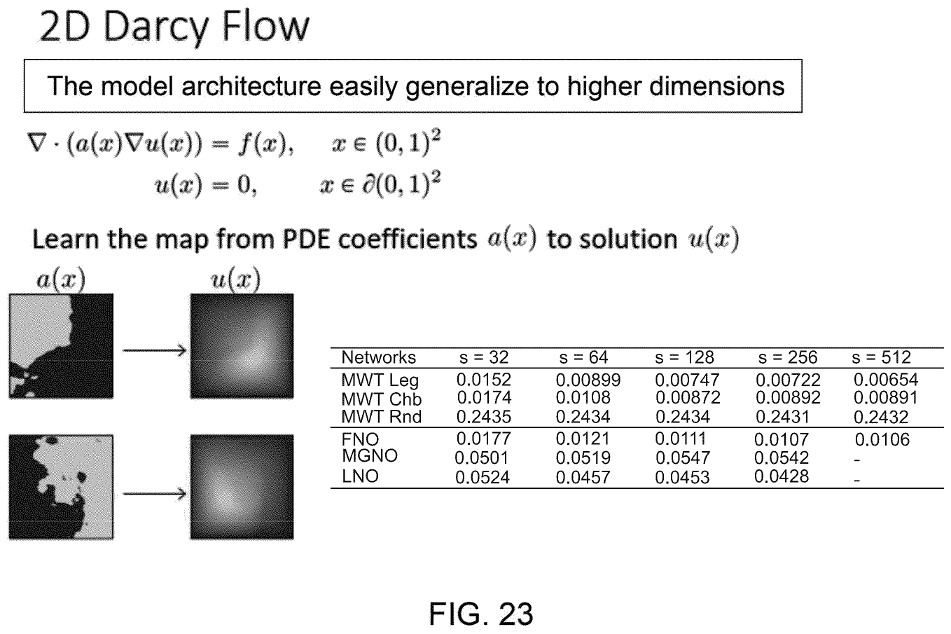

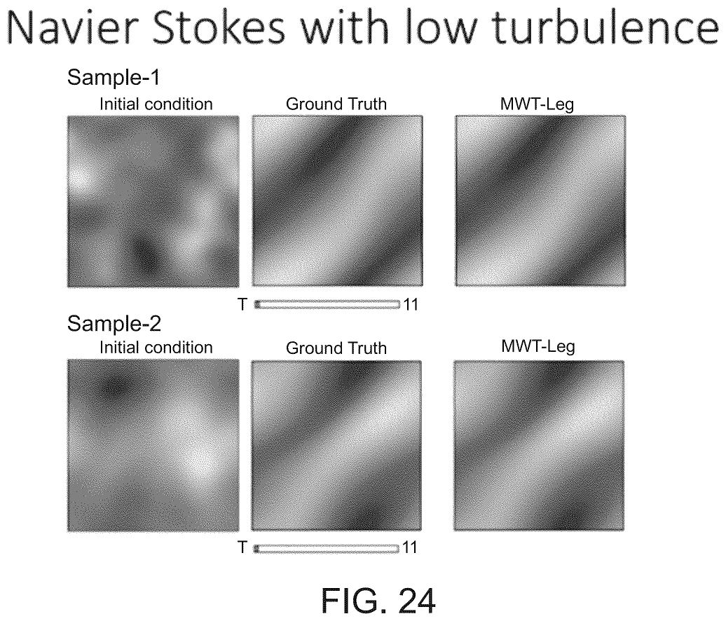

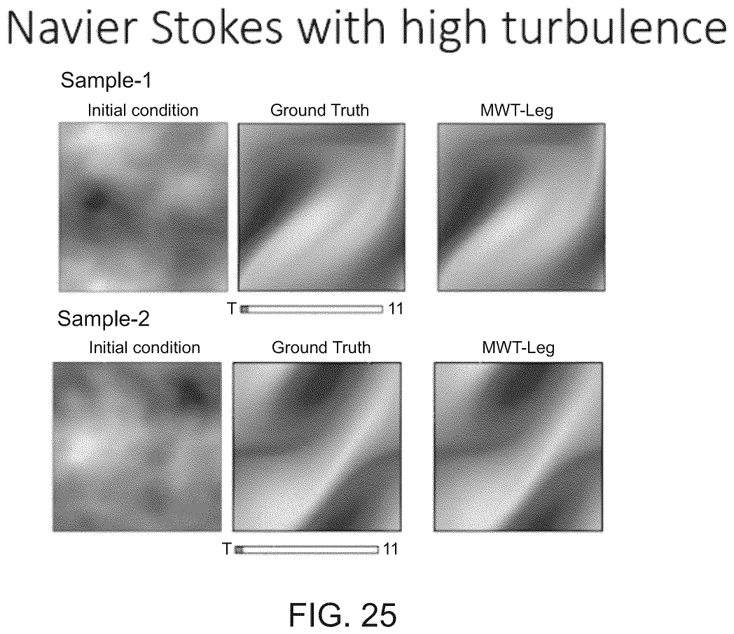

At step 2710, the method can include determining whether there is additional data to process. For example, if the transformed data (e.g., which may be a sequence of data) includes enough data to be bisected into two groups of data, the set of data may be bisected and provided and subsequently treated as the input data for a subsequent iteration at STEP 2706. The selected subset of information (e.g., as shown in FIG. 22) may then be provided as input to the identified filters and subsequently provided as input to further machine learning models. If no additional data can be split or processed, the method 2700 can proceed to step 2712 to produce a final output value. The number of iterations can depend on the number of models used to process the data (e.g., three models use three iterations, seven models use four iterations, etc.).

At step 2712, the method can include summing to generate an output. The summing process can follow the right-hand portion of FIG. 22, which shows a “ladder up” combination of the sets of output data being added together and provided as input to the identified filter functions. As shown in FIG. 22, the output data set of the final iteration may be summed with a portion of the output data from the previous iteration that was used to create the final iteration. This sum, along with the other data from the previous iteration, can be provided as input to the identified filter functions. This “ladder up” process can be repeated using the output of the filter functions until a final output value is calculated, as shown in FIG. 22.

FIGS. 28A and 28B depict block diagrams of a computing device 2800 useful for practicing implementations of the computing devices described herein. As shown in FIGS. 28A and 28B, each computing device 2800 includes a central processing unit 2821, and a main memory unit 2822. As shown in FIG. 28A, a computing device 2800 may include a storage device 2828, an installation device 2816, a network interface 2818, an I/O controller 2823, display devices 2824a-824n, a keyboard 2826 and a pointing device 2827, such as a mouse. The storage device 2828 may include, without limitation, an operating system and/or software. As shown in FIG. 28B, each computing device 2800 may also include additional optional elements, such as a memory port 2803, a bridge 2870, one or more input/output devices 2830a-830n (generally referred to using reference numeral 2830), and a cache memory 2840 in communication with the central processing unit 2821.

The central processing unit 2821 is any logic circuitry that responds to and processes instructions fetched from the main memory unit 2822. In many implementations, the central processing unit 2821 is provided by a microprocessor unit, such as: those manufactured by Intel Corporation of Mountain View, California; those manufactured by International Business Machines of White Plains, New York; those manufactured by Advanced Micro Devices of Sunnyvale, California; or those manufactured by Advanced RISC Machines (ARM). The computing device 2800 may be based on any of these processors, or any other processors capable of operating as described herein.

Main memory unit 2822 may be one or more memory chips capable of storing data and allowing any storage location to be directly accessed by the microprocessor 2821, such as any type or variant of Static random access memory (SRAM), Dynamic random access memory (DRAM), Ferroelectric RAM (FRAM), NAND Flash, NOR Flash and Solid State Drives (SSD). The main memory 2822 may be based on any of the above described memory chips, or any other available memory chips capable of operating as described herein. In the implementation shown in FIG. 28A, the processor 2821 communicates with main memory 2822 via a system bus 2850 (described in more detail below). FIG. 28B depicts an implementation of a computing device 2800 in which the processor communicates directly with main memory 2822 via a memory port 2803. For example, in FIG. 28B the main memory 2822 may be DRDRAM.

FIG. 28B depicts an implementation in which the main processor 2821 communicates directly with cache memory 2840 via a secondary bus, sometimes referred to as a backside bus. In other implementations, the main processor 2821 communicates with cache memory 2840 using the system bus 2850. Cache memory 2840 typically has a faster response time than main memory 2822 and is provided by, for example, SRAM, BSRAM, or EDRAM. In the implementation shown in FIG. 28B, the processor 2821 communicates with various I/O devices 2830 via a local system bus 2850. Various buses may be used to connect the central processing unit 2821 to any of the I/O devices 2830, for example, a VESA VL bus, an ISA bus, an EISA bus, a MicroChannel Architecture (MCA) bus, a PCI bus, a PCI-X bus, a PCI-Express bus, or a NuBus. For implementations in which the I/O device is a video display 2824, the processor 2821 may use an Advanced Graphics Port (AGP) to communicate with the display 2824. FIG. 28B depicts an implementation of a computer 2800 in which the main processor 2821 may communicate directly with I/O device 2830b, for example via HYPERTRANSPORT, RAPIDIO, or INFINIBAND communications technology. FIG. 28B also depicts an implementation in which local busses and direct communication are mixed: the processor 2821 communicates with I/O device 2830a using a local interconnect bus while communicating with I/O device 2830b directly.

A wide variety of I/O devices 2830a-830n may be present in the computing device 2800. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 2823 as shown in FIG. 28A. The I/O controller may control one or more I/O devices such as a keyboard 2826 and a pointing device 2827, e.g., a mouse or optical pen. Furthermore, an I/O device may also provide storage and/or an installation medium 2816 for the computing device 2800. In still other implementations, the computing device 2800 may provide USB connections (not shown) to receive handheld USB storage devices such as the USB Flash Drive line of devices manufactured by Twintech Industry, Inc. of Los Alamitos, California.

Referring again to FIG. 28A, the computing device 2800 may support any suitable installation device 2816, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 2800 may further include a storage device, such as one or more hard disk drives or redundant arrays of independent disks, for storing an operating system and other related software, and for storing application software programs such as any program or software 2820 for implementing (e.g., configured and/or designed for) the systems and methods described herein. Optionally, any of the installation devices 2816 could also be used as the storage device. Additionally, the operating system and the software can be run from a bootable medium.

Furthermore, the computing device 2800 may include a network interface 2818 to interface to the network 2804 through a variety of connections including, but not limited to, standard telephone lines, LAN or WAN links (e.g., 2802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 2802.11, IEEE 2802.11a, IEEE 2802.11b, IEEE 2802.11g, IEEE 2802.11n, IEEE 2802.11ac, IEEE 2802.11ad, CDMA, GSM, WiMax and direct asynchronous connections). In one implementation, the computing device 2800 communicates with other computing devices 2800′ via any type and/or form of gateway or tunneling protocol such as Secure Socket Layer (SSL) or Transport Layer Security (TLS). The network interface 2818 may include a built-in network adapter, network interface card, PCMCIA network card, card bus network adapter, wireless network adapter, USB network adapter, modem or any other device suitable for interfacing the computing device 2800 to any type of network capable of communication and performing the operations described herein.

In some implementations, the computing device 2800 may include or be connected to one or more display devices 2824a-824n. As such, any of the I/O devices 2830a-830n and/or the I/O controller 2823 may include any type and/or form of suitable hardware, software, or combination of hardware and software to support, enable or provide for the connection and use of the display device(s) 2824a-824n by the computing device 2800. For example, the computing device 2800 may include any type and/or form of video adapter, video card, driver, and/or library to interface, communicate, connect or otherwise use the display device(s) 2824a-824n. In one implementation, a video adapter may include multiple connectors to interface to the display device(s) 2824a-824n. In other implementations, the computing device 2800 may include multiple video adapters, with each video adapter connected to the display device(s) 2824a-824n. In some implementations, any portion of the operating system of the computing device 2800 may be configured for using multiple displays 2824a-824n. One ordinarily skilled in the art will recognize and appreciate the various ways and implementations that a computing device 2800 may be configured to have one or more display devices 2824a-824n.

In further implementations, an I/O device 2830 may be a bridge between the system bus 2850 and an external communication bus, such as a USB bus, an Apple Desktop Bus, an RS-232 serial connection, a SCSI bus, a FireWire bus, a FireWire 2800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

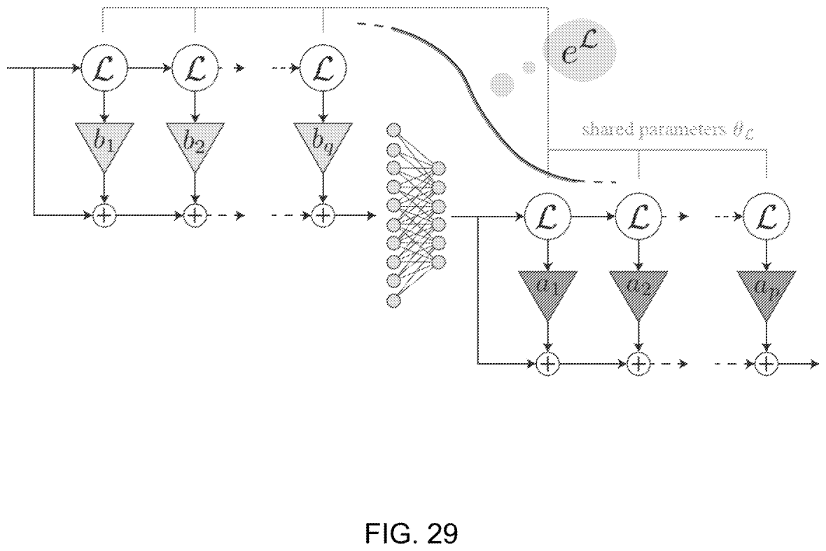

FIG. 29 illustrates an example recurrent neural architecture, in accordance with one or more implementations. For example, a recurrent neural architecture for computing the exponential of an operator L using [p/q] Pade approximation. The multiplicative scalar coefficients ai, bi can be fixed-beforehand. The non-linear fully-connected layer can be used to mimic the inverse polynomial operation.

This technical solution is also directed to to explicitly embed the exponential operators in the neural operator architecture for dealing with the IVP like datasets. The exponential operators are non-linear, and therefore, this removes the requirement of having multi-cell linear integral operator layers. However, this is seldom a feasible scenario for the expensive real-world experiments, or on-going recent issues like COVID19 prediction. This technical solution is helpful in providing data-efficiency analytics, and is useful in dealing with scarce and noisy datasets. To the advantage of Pade approximation, the exponential of a ′ given operator can be computed with the pre-defined coefficients and a recurrent polynomial mechanism.

This technical solution can: (i) For the IVPs, we propose to embed the exponential operators in the neural operator learning mechanism. (ii) By using the Pade approximation, we compute the exponential of the operator using a novel ′ recurrent neural architecture that also eliminates the need for matrix inversion. (iii) This technical solution can demonstrate that the proposed recurrent scheme, using the Pade coefficients, have bounded gradients ′ with respect to (w.r.t.) the model parameters across the recurrent horizon. (iv) We demonstrate the data-efficiency on the synthetic 1D datasets of Korteweg-de Vries (KdV) and Kuramoto-Sivashinsky (KS) equations, where with less parameters we achieve state-of-the-art performance. (v) For example, a system can formulate and investigate epidemic forecasting as a 2D time-varying neural operator problem, and show that for real-world noisy and scarce data, the proposed model can, for example, outperform the best neural operator architectures by at least 53% and best non-neural operator schemes by at least 52%. For example, a system can include a Pade Model Implementation. The operator L can be fixed as a single-layered convolution operator for 1D datasets, and 2-layered convolution for 2D datasets. For getting the input/output operator mapping, the multiwavelet transform can be used only for discretizing the spatial domain. A Pade neural model fits into the sockets of the multiwavelet transformation based neural operator ′. The multiwavelet filters can be obtained using shifted Legendre OPs with degree K″4.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to view videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device.

The operations described in this specification can be implemented as operations performed by a data processing apparatus on data stored on one or more computer-readable storage devices or received from other sources.

The terms “data processing apparatus”, “feature extraction system,” “data processing system”, “client device”, “computing platform”, “computing device”, or “device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the feature extraction system 105 can include clients and servers. For example, the feature extraction system 105 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a user interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the feature extraction system 105 could be a single module, or a logic device having one or more processing modules.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided may be useful for multiwavelet-based operator learning for differential equations, the systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

What is claimed is:

1. A system to execute a model performing multiwavelet-based operator learning, the system comprising:
a processor and memory to:
identify a multiwavelet filter configured to take as input including items of data corresponding to a particular application;
transform, by the filter, the data into one or more subsets; and
generate, by a model receiving one or more of the transformed subsets as input, a set of output data corresponding to the particular application.

2. The system of claim 1, the model comprising one or more of a deep neural network, a convolutional neural network, a recurrent neural network, and a fully connected neural network.

3. The system of claim 1, the model comprising a plurality of models each having same hyperparameters.

4. The system of claim 1, the model comprising a plurality of models each having different hyperparameters.

5. The system of claim 1, the processor to:
select, based on the particular application, the model.

6. The system of claim 1, the processor to:
determine, based on an amount of the data, to transform the data into two bisected groups of data having equal size.

7. The system of claim 1, the processor to:
select, based on a type of differential equation provided as input to the MWT filter, the MWT filter.

8. The system of claim 1, the processor to:
generate the output data set based on a portion of an output data corresponding to a previous iteration used to create the final iteration.

9. A method to execute a model performing multiwavelet-based operator learning, the method comprising:
identifying a multiwavelet filter configured to take as input including items of data corresponding to a particular application;
transforming, by the filter, the data into one or more subsets; and
generating, by a model receiving one or more of the transformed subsets as input, a set of output data corresponding to the particular application.

10. The method of claim 9, the model comprising one or more of a deep neural network, a convolutional neural network, a recurrent neural network, and a fully connected neural network.

11. The method of claim 9, the model comprising a plurality of models each having same hyperparameters.

12. The method of claim 9, the model comprising a plurality of models each having different hyperparameters.

13. The method of claim 9, further comprising:
select, based on the particular application, the model.

14. The method of claim 9, further comprising:
determine, based on an amount of the data, to transform the data into two bisected groups of data having equal size.

15. The method of claim 9, further comprising:
select, based on a type of differential equation provided as input to the MWT filter, the MWT filter.

16. The method of claim 9, further comprising:
generate the output data set based on a portion of an output data corresponding to a previous iteration used to create the final iteration.

17. A computer readable medium including one or more instructions stored thereon and executable by a processor to:
identify, by the processor, a multiwavelet filter configured to take as input including items of data corresponding to a particular application;
transform, by the processor via the filter, the data into one or more subsets; and
generate, by the processor via a model receiving one or more of the transformed subsets as input, a set of output data corresponding to the particular application.

18. The computer readable medium of claim 17, the model comprising one or more of a deep neural network, a convolutional neural network, a recurrent neural network, and a fully connected neural network.

19. The computer readable medium of claim 17, the model comprising a plurality of models each having same hyperparameters.

20. The computer readable medium of claim 17, the model comprising a plurality of models each having different hyperparameters.
